(19) United States
(12) Patent Application Publication
(10) Pub. No.: US 2010/0066983 A1
(43) Pub. Date: Mar. 18, 2010

(54) Methods and systems related to a projection surface

(76) Inventors: Edward K.Y. Jun, Bellevue, WA (US); Eric C. Leuthardt, St. Louis, MO (US); Royce A. Levien, Lexington, MA (US); Richard T. Lord, Tacoma, WA (US); Robert W. Lord, Seattle, WA (US); Mark A. Malamud, Seattle, WA (US); John D. Rinaldo, JR., Bellevue, WA (US); Lowell L. Wood, JR., Bellevue, WA (US)

Correspondence Address: Constellation Law Group, PLLC, P.O. Box 220, Tracyton, WA, 98393, US

(21) Appl. No.: 12/459,581

(22) Filed: Jul. 2, 2009

Related U.S. Application Data
(63) Continuation-in-part of application No. 12/454,184, filed on May 12, 2009.
Application No. 12/454,184 is a continuation-in-part of application No. 12/214,422, filed on Jun. 17, 2008.
Application No. 12/214,422 is a continuation-in-part of application No. 12/217,118, filed on Jun. 30, 2008.
Application No. 12/217,118 is a continuation-in-part of application No. 12/217,116, filed on Jun. 30, 2008.
Application No. 12/217,116 is a continuation-in-part of application No. 12/217,115, filed on Jun. 30, 2008.
Application No. 12/217,115 is a continuation-in-part of application No. 12/217,123, filed on Jun. 30, 2008.
Application No. 12/217,123 is a continuation-in-part of application No. 12/217,135, filed on Jun. 30, 2008.
Application No. 12/217,135 is a continuation-in-part of application No. 12/217,117, filed on Jun. 30, 2008.
Application No. 12/217,117 is a continuation-in-part of application No. 12/218,269, filed on Jul. 11, 2008.
Application No. 12/218,269 is a continuation-in-part of application No. 12/218,266, filed on Jul. 11, 2008.
Application No. 12/218,266 is a continuation-in-part of application No. 12/218,267, filed on Jul. 11, 2008.
Application No. 12/218,267 is a continuation-in-part of application No. 12/218,268, filed on Jul. 11, 2008.
Application No. 12/218,268 is a continuation-in-part of application No. 12/220,906, filed on Jul. 28, 2008.
Application No. 12/220,906 is a continuation-in-part of application No. 12/229,534, filed on Aug. 22, 2008.
Application No. 12/229,534 is a continuation-in-part of application No. 12/229,518, filed on Aug. 22, 2008.
Application No. 12/229,518 is a continuation-in-part of application No. 12/229,505, filed on Aug. 22, 2008.
Application No. 12/229,505 is a continuation-in-part of application No. 12/229,519, filed on Aug. 22, 2008.
Application No. 12/229,519 is a continuation-in-part of application No. 12/229,536, filed on Aug. 22, 2008.
Application No. 12/229,536 is a continuation-in-part of application No. 12/229,508, filed on Aug. 22, 2008.
Application No. 12/229,508 is a continuation-in-part of application No. 12/286,731, filed on Sep. 30, 2008.
Application No. 12/286,731 is a continuation-in-part of application No. 12/286,750, filed on Sep. 30, 2008.
Application No. 12/286,750 is a continuation-in-part of application No. 12/290,240, filed on Oct. 27, 2008.
Application No. 12/290,240 is a continuation-in-part of application No. 12/290,241, filed on Oct. 27, 2008.
Application No. 12/290,241 is a continuation-in-part of application No. 12/291,019, filed on Oct. 30, 2008.
Application No. 12/291,019 is a continuation-in-part of application No. 12/291,024, filed on Oct. 30, 2008.
Application No. 12/291,024 is a continuation-in-part of application No. 12/291,023, filed on Oct. 30, 2008.
Application No. 12/291,023 is a continuation-in-part of application No. 12/291,025, filed on Oct. 30, 2008.
Application No. 12/291,025 is a continuation-in-part of application No. 12/322,063, filed on Jan. 27, 2009.
Application No. 12/322,063 is a continuation-in-part of application No. 12/322,875, filed on Feb. 5, 2009.
Application No. 12/322,875 is a continuation-in-part of application No. 12/322,876, filed on Feb. 5, 2009.
Application No. 12/322,876 is a continuation-in-part of application No. 12/380,595, filed on Feb. 27, 2009.
Application No. 12/380,595 is a continuation-in-part of application No. 12/380,571, filed on Feb. 27, 2009.
Application No. 12/380,571 is a continuation-in-part of application No. 12/380,582, filed on Feb. 27, 2009.
Application No. 12/380,582 is a continuation-in-part of application No. 12/454,184, filed on May 12, 2009.

(51) Int. Cl. G03B 21/14; G03B 21/00

(52) U.S. Cl. 353/79; 353/121

(57) ABSTRACT

The present disclosure relates generally to systems and methods that are related to a projection surface. For example, in some implementations, a method includes receiving projection input with one or more projection surfaces from one or more projectors; comparing at least a portion of the projection input with one or more benchmarks; and initiating an action in response to the comparing at least a portion of the projection input with one or more benchmarks.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)).

### RELATED APPLICATIONS

For purposes of the USPTO extra-statutory requirements, the present application constitutes a continuation-in-part of U.S. patent application Ser. No. 12/214,422, entitled SYSTEMS AND DEVICES, naming Edward K. Y. Jung, Eric C. Leuthardt, Royce A. Levien, Robert W. Lord, Mark A. Malamud, John D. Rinaldo, Jr., and Lowell L. Wood, Jr. as inventors, filed 17 Jun. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/217,118, entitled MOTION RESPONSIVE DEVICES AND SYSTEMS, naming Edward K. Y. Jung, Eric C. Leuthardt, Royce A. Levien, Robert W. Lord, Mark A. Malamud, John D. Rinaldo, Jr., and Lowell L. Wood, Jr. as inventors, filed 30 Jun. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/217,116, entitled SYSTEMS AND METHODS FOR PROJECTING, naming Edward K. Y. Jung, Eric C. Leuthardt, Royce A. Levien, Robert W. Lord, Mark A. Malamud, John D. Rinaldo, Jr., and Lowell L. Wood, Jr. as inventors, filed 30 Jun. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/217,115, entitled SYSTEMS AND METHODS FOR TRANSMITTING INFORMATION ASSOCIATED WITH PROJECTING, naming Edward K. Y. Jung, Eric C. Leuthardt, Royce A. Levien, Robert W. Lord, Mark A. Malamud, John D. Rinaldo, Jr., and Lowell L. Wood, Jr. as inventors, filed 30 Jun. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/217,123, entitled SYSTEMS AND METHODS FOR RECEIVING INFORMATION ASSOCIATED WITH PROJECTING, naming Edward K. Y. Jung, Eric C. Leuthardt, Royce A. Levien, Robert W. Lord, Mark A. Malamud, John D. Rinaldo, Jr., and Lowell L. Wood, Jr. as inventors, filed 30 Jun. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/217,135, entitled SYSTEMS AND METHODS FOR PROJECTING IN RESPONSE TO POSITION, naming Edward K. Y. Jung, Eric C. Leuthardt, Royce A. Levien, Robert W. Lord, Mark A. Malamud, John D. Rinaldo, Jr., and Lowell L. Wood, Jr. as inventors, filed 30 Jun. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/217,117, entitled SYSTEMS AND METHODS FOR PROJECTING IN RESPONSE TO CONFORMATION, naming Edward K. Y. Jung, Eric C. Leuthardt, Royce A. Levien, Robert W. Lord, Mark A. Malamud, John D. Rinaldo, Jr., and Lowell L. Wood, Jr. as inventors, filed 30 Jun. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/218,269, entitled SYSTEMS AND METHODS FOR TRANSMITTING IN RESPONSE TO POSITION, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 11 Jul. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/218,266, entitled SYSTEMS AND METHODS FOR PROJECTING IN RESPONSE TO POSITION, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 11 Jul. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/218,267, entitled SYSTEMS AND METHODS ASSOCIATED WITH PROJECTING IN RESPONSE TO CONFORMATION, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 11 Jul. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/218,268, entitled SYSTEMS AND METHODS ASSOCIATED WITH PROJECTING IN RESPONSE TO CONFORMATION, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 11 Jul. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/220,906, entitled METHODS AND SYSTEMS FOR RECEIVING AND TRANSMITTING SIGNALS ASSOCIATED WITH PROJECTION, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 28 Jul. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/229,534, entitled PROJECTION IN RESPONSE TO POSITION, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 22 Aug. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/229,518, entitled PROJECTION IN RESPONSE TO CONFORMATION, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 22 Aug. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/229,505, entitled METHODS AND SYSTEMS FOR PROJECTING IN RESPONSE TO POSITION, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 22 Aug. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/229,519, entitled METHODS AND SYSTEMS FOR PROJECTING IN RESPONSE TO POSITION, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 22 Aug. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/229,536, entitled METHODS AND SYSTEMS FOR PROJECTING IN RESPONSE TO CONFORMATION, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 22 Aug. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/229,508, entitled METHODS AND SYSTEMS FOR PROJECTING IN RESPONSE TO CONFORMATION, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 22 Aug. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/286,731, entitled PROJECTION ASSOCIATED METHODS AND SYSTEMS, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 30 Sep. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/286,750, entitled PROJECTION ASSOCIATED METHODS AND SYSTEMS, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 30 Sep. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/290,240, entitled METHODS ASSOCIATED WITH RECEIVING AND TRANSMITTING INFORMATION RELATED TO PROJECTION, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 27 Oct. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/290,241, entitled SYSTEMS ASSOCIATED WITH RECEIVING AND TRANSMITTING INFORMATION RELATED TO PROJECTION, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 27 Oct. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/291,019, entitled METHODS ASSOCIATED WITH PROJECTION BILLING, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 30 Oct. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/291,024, entitled SYSTEMS ASSOCIATED WITH PROJECTION BILLING, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 30 Oct. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/291,023, entitled METHODS ASSOCIATED WITH PROJECTION SYSTEM BILLING, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 30 Oct. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/291,025, entitled SYSTEMS ASSOCIATED WITH PROJECTION SYSTEM BILLING, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 30 Oct. 2008, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/322,063, entitled METHODS AND SYSTEMS FOR USER PARAMETER RESPONSIVE PROJECTION, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 27 Jan. 2009, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/322,875, entitled METHODS AND SYSTEMS FOR TRANSMITTING INSTRUCTIONS ASSOCIATED WITH USER PARAMETER RESPONSIVE PROJECTION, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 5 Feb. 2009, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/322,876, entitled METHODS AND SYSTEMS FOR RECEIVING INSTRUCTIONS ASSOCIATED WITH USER PARAMETER RESPONSIVE PROJECTION, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 5 Feb. 2009, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/380,595,

entitled METHODS AND SYSTEMS FOR COORDINATED USE OF TWO OR MORE USER RESPONSIVE PROJECTORS, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 27 Feb. 2009, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/380,571, entitled METHODS AND SYSTEMS FOR TRANSMITTING INFORMATION ASSOCIATED WITH THE coordinated use of two or more user responsive projectors, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 27 Feb. 2009, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/380,582, entitled METHODS AND SYSTEMS FOR RECEIVING INFORMATION ASSOCIATED WITH THE COORDINATED USE OF TWO OR MORE USER RESPONSIVE PROJECTORS, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 27 Feb. 2009, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 12/454,184, entitled METHODS AND SYSTEMS RELATED TO AN IMAGE CAPTURE PROJECTION SURFACE, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 12 May 2009, which is currently co-pending, or is an application of which a currently co-pending application is entitled to the benefit of the filing date.

For purposes of the USPTO extra-statutory requirements, the present application constitutes a continuation-in-part of U.S. patent application No. Unknown, entitled DEVICES RELATED TO PROJECTION INPUT SURFACES, naming Edward K. Y. Jung, Eric C. Leuthardt, Royce A. Levien, Richard T. Lord, Robert W. Lord, Mark A. Malamud, John D. Rinaldo, Jr., and Lowell L. Wood, Jr. as inventors, filed 2 Jul. 2009, under Attorney Docket No. SE1-0091C1-US, which is currently co-pending, or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar. 18, 2003, available at http://www.uspto.gov////////.htm. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent such subject matter is not inconsistent herewith.

### TECHNICAL FIELD

The present disclosure relates to systems and methods that are related to a projection surface.

### SUMMARY

In one aspect, a method includes but is not limited to receiving projection input with one or more projection surfaces from one or more projectors; comparing at least a portion of the projection input with one or more benchmarks; and initiating an action in response to the comparing at least a portion of the projection input with one or more benchmarks. In addition to the foregoing, other aspects are described in the claims, drawings, and text forming a part of the present disclosure.

In one aspect, a system includes but is not limited to circuitry for receiving projection input with one or more projection surfaces from one or more projectors; circuitry for comparing at least a portion of the projection input with one or more benchmarks; and circuitry for initiating an action in response to the comparing at least a portion of the projection input with one or more benchmarks. In addition to the foregoing, other aspects are described in the claims, drawings, and text forming a part of the present disclosure.

In one aspect, a system includes but is not limited to a signal-bearing medium bearing one or more instructions for receiving projection input with one or more projection surfaces from one or more projectors; one or more instructions for comparing at least a portion of the projection input with one or more benchmarks; and one or more instructions for initiating an action in response to the comparing at least a portion of the projection input with one or more benchmarks. In addition to the foregoing, other aspects are described in the claims, drawings, and text forming a part of the present disclosure.

In one aspect, a system includes but is not limited to an article of manufacture including but not limited to a signal-bearing medium configured by one or more instructions related to: receiving projection input with one or more projection surfaces from one or more projectors; comparing at least a portion of the projection input with one or more benchmarks; and initiating an action in response to the comparing at least a portion of the projection input with one or more benchmarks. In addition to the foregoing, other system aspects are described in the claims, drawings, and text forming a part of the present disclosure.

In one aspect, a system includes but is not limited to means for receiving projection input with one or more projection surfaces from one or more projectors; means for comparing at least a portion of the projection input with one or more benchmarks; and means for initiating an action in response to the comparing at least a portion of the projection input with one or more benchmarks. In addition to the foregoing, other system aspects are described in the claims, drawings, and text forming a part of the present disclosure.

In one or more various aspects, means include but are not limited to circuitry and/or programming for effecting the herein referenced functional aspects; the circuitry and/or programming can be virtually any combination of hardware, software, and/or firmware configured to effect the herein referenced functional aspects depending upon the design choices of the system designer. In addition to the foregoing, other system aspects means are described in the claims, drawings, and/or text forming a part of the present disclosure.

In one or more various aspects, related systems include but are not limited to circuitry and/or programming for effecting the herein-referenced method aspects; the circuitry and/or programming can be virtually any combination of hardware, software, and/or firmware configured to effect the herein referenced method aspects depending upon the design choices of the system designer. In addition to the foregoing, other system aspects are described in the claims, drawings, and/or text forming a part of the present application.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE FIGURES

FIG. 1 illustrates an example system in which embodiments may be implemented.

FIGS. 2-9 illustrate embodiments of components shown in FIG. 1.

FIG. 10 illustrates an operational flow representing example operations related to receiving projection input with one or more projection surfaces from one or more projectors; comparing at least a portion of the projection input with one or more benchmarks; and initiating an action in response to the comparing at least a portion of the projection input with one or more benchmarks.

FIGS. 11-17 illustrate alternative embodiments of the example operation flow of FIG. 10.

FIG. 18 illustrates an example computer system for implementing embodiments.

FIG. 19 illustrates an example article of manufacture for implementing embodiments.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

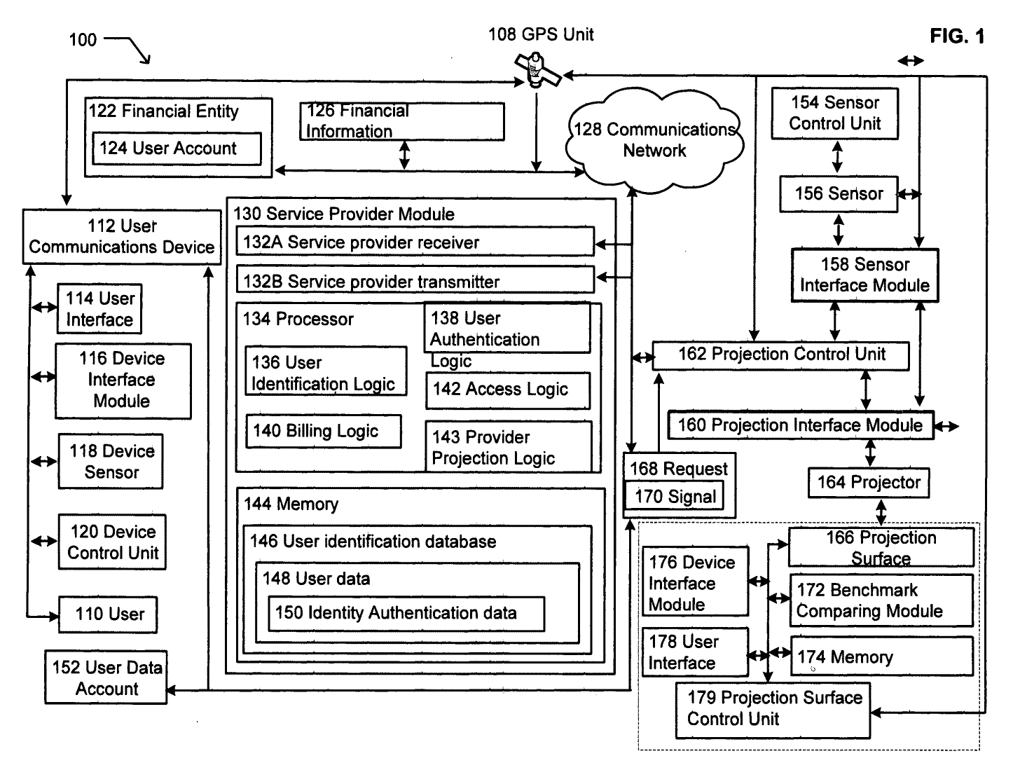

FIG. 1 illustrates an example system 100 in which embodiments may be implemented. In some embodiments, system 100 may include one or more user communications devices 112. In some embodiments, system 100 may include one or more user device interfaces 114. In some embodiments, system 100 may include one or more user device interface modules 116. In some embodiments, system 100 may include one or more device sensors 118. In some embodiments, system 100 may include one or more device control units 120. In some embodiments, system 100 may be configured to communicate with one or more users 110. In some embodiments, system 100 may include one or more sensor control units 154. In some embodiments, system 100 may include one or more sensors 156. In some embodiments, system 100 may include one or more sensor interface modules 158. In some embodiments, system 100 may include one or more projection control units 162. In some embodiments, system 100 may include one or more projectors 164. In some embodiments, system 100 may include one or more projectors 164 that are configured to project in coordination with one or more other projectors 164. In some embodiments, system 100 may include one or more projection interface modules 160. In some embodiments, system 100 may include one or more projection surfaces 166. In some embodiments, system 100 may be configured to communicate with one or more communications networks 128. In some embodiments, system 100 may be configured to communicate with one or more service provider modules 130. In some embodiments, a service provider module 130 may include one or more service provider receivers 132A. In some embodiments, a service provider module 130 may include one or more service provider transmitters 132B. In some embodiments, a service provider module 130 may include one or more processors 134. In some embodiments, a service provider module 130 may include user identification logic 136. In some embodiments, a service provider module 130 may include billing logic 140. In some embodiments, a service provider module 130 may include user authentication logic 138. In some embodiments, a service provider module 130 may include access logic 142. In some embodiments, a service provider module 130 may include provider projection logic 143. In some embodiments, a service provider module 130 may include provider memory 144. In some embodiments, a service provider module 130 may include one or more user identification databases 146. In some embodiments, a service provider module 130 may include user data 148. In some embodiments, a service provider module 130 may include identity authentication data 150. In some embodiments, system 100 may be configured to communicate with one or more financial entities 122. In some embodiments, a financial entity 122 may include one or more user accounts 124. In some embodiments, system 100 may include financial information 126. In some embodiments, system 100 may include one or more user data accounts 152. In some embodiments, system 100 may include one or more projection surfaces 166. In some embodiments, system 100 may include one or more benchmark comparing modules 172. In some embodiments, system 100 may include one or more memory 174. In some embodiments, system 100 may include one or more projection surface control units 179. In some embodiments, system 100 may include one or more device interface modules 176. In some embodiments, system 100 may include one or more user interfaces 178.

### User Communications Device

In some embodiments, system 100 may include one or more user communications devices 112. A user communications device 112 may be configured in numerous ways. For example, in some embodiments, a user communications device 112 may be configured as a personal digital assistant (PDA). In some embodiments, a user communications device 112 may be configured as a cellular telephone. In some embodiments, a user communications device 112 may be configured as a computer (e.g., a laptop computer).

In some embodiments, a user communications device 112 may be operably associated with one or more user device interfaces 114. User device interfaces 114 may be configured in numerous ways. Examples of such configurations include, but are not limited to, touchscreens, keyboards, and the like. In some embodiments, a user device interface 114 may be configured as a gestural user device interface 114A. For example, in some embodiments, a user device interface 114 may be configured to respond to one or more physical actions. Examples of such physical actions include, but are not limited to, acceleration, negative acceleration, shock, squeeze, movement (e.g., substantially defined motions), and the like. In some embodiments, one or more user device interfaces 114 may be configured to be programmable to respond to one or more gestures. For example, in some embodiments, one or more user device interfaces 114 may be configured to respond to pressure produced by squeezing the user device interface 114. In some embodiments, one or more user device interfaces 114 may be configured to respond to one or more motions. Accordingly, one or more user device interfaces 114 may be configured to respond to numerous types of gestures. In some embodiments, one or more user device interfaces 114 may be configured to include one or more tactile interfaces 114B. In some embodiments, one or more user device interfaces 114 may be configured to utilize vibration to interact with a user 110. For example, in some embodiments, a user device interface 114 may be configured to vibrate if a user communications device 112 enters into proximity with one or more available projection control units 162. Accordingly, a user device interface 114 may be configured to utilize numerous tactile interfaces 114B.

In some embodiments, a user communications device 112 may be operably associated with one or more user device interface modules 116. In some embodiments, one or more user device interface modules 116 may be configured to operably communicate with one or more projectors 164. In some embodiments, one or more projection interface modules 160 may be configured to operably communicate with one or more projection control units 162. In some embodiments, one or more projection interface modules 160 may be configured to operably communicate with one or more projection interface modules 160. In some embodiments, one or more user device interface modules 116 may be configured to operably communicate with one or more service provider receivers 132A. In some embodiments, one or more user device interface modules 116 may be configured to operably communicate with one or more service provider transmitters 132B. In some embodiments, one or more user device interface modules 116 may be configured to operably communicate with one or more service provider modules 130. In some embodiments, one or more user device interface modules 116 may be configured to operably communicate with one or more sensors 156. In some embodiments, one or more user device interface modules 116 may be configured to operably communicate with one or more sensor interface modules 158. In some embodiments, one or more user device interface modules 116 may be configured to operably communicate with one or more sensor control units 154. In some embodiments, one or more user device interface modules 116 may be configured to operably communicate with one or more financial entities 122. In some embodiments, one or more user device interface modules 116 may be configured to operably communicate with one or more communications networks 128. In some embodiments, one or more user device interface modules 116 may be configured to operably communicate with one or more projection surfaces 166. In some embodiments, one or more user device interface modules 116 may be configured to operably communicate with one or more device interface modules 176. In some embodiments, one or more user device interface modules 116 may be configured to operably communicate with one or more user interfaces 178. In some embodiments, one or more user device interface modules 116 may be configured to operably communicate with one or more benchmark comparing modules 172. In some embodiments, one or more user device interface modules 116 may be configured to operably communicate with one or more memory 174. In some embodiments, one or more user device interface modules 116 may be configured to operably communicate with one or more projection surface control units 179. A user device interface module 116 may communicate with other components of system 100 through use of numerous communication formats and combinations of communication formats using one or more device transmitters 116K and/or one or more device receivers 116L. Examples of such formats include, but are not limited to, 116A VGA, 116D USB, 116I wireless USB, 116B RS-232, 116E infrared, 116J Bluetooth, 116C 802.11b/g/n, 116F S-video, 116H Ethernet, 116G DVI-D, and the like. In some embodiments, one or more user device interface modules 116 may be configured to receive information from one or more global positioning units 108.

In some embodiments, a user communications device 112 may be operably associated with one or more device sensors 118. A user communications device 112 may be operably associated with many types of device sensors 118 alone or in combination. Examples of device sensors 118 include, but are not limited to, 118P cameras, 118H light sensors, 118O range sensors, 118G contact sensors, 118K entity sensors, 118L infrared sensors, 118M yaw rate sensors, 118N ultraviolet sensors, 118E inertial sensors, 118F ultrasonic sensors, 118I imaging sensors, 118J pressure sensors, 118A motion sensors, 118B gyroscopic sensors, 118C acoustic sensors, 118D biometric sensors, and the like. In some embodiments, one or more device sensors 118 may be configured to detect motion. In some embodiments, one or more device sensors 118 may be configured to detect motion that is imparted to one or more user communications devices 112. In some embodiments, one or more device sensors 118 may be configured to detect one or more projectors 164. In some embodiments, one or more device sensors 118 may be configured to detect one or more projection interface modules 160. In some embodiments, one or more device sensors 118 may be configured to detect one or more projection control units 162. In some embodiments, one or more device sensors 118 may be configured to detect one or more users 110. In some embodiments, one or more device sensors 118 may be configured to detect one or more individuals. In some embodiments, one or more device sensors 118 may be configured to detect one or more additional user communications devices 112. In some embodiments, one or more device sensors 118 may be configured to detect one or more projection surfaces 166.

In some embodiments, a user communications device 112 may be operably associated with one or more device control units 120. In some embodiments, a device control unit 120 may be operably associated with one or more device processors 120A. In some embodiments, a device control unit 120 may be configured to process one or more instructions. For example, in some embodiments, one or more device control units 120 may process information associated with prioritization of projection. In some embodiments, one or more device control units 120 may process information associated with scheduling projection. Accordingly, in some embodiments, one or more device control units 120 may act to control the transmission of information associated with projection. In some embodiments, one or more device control units 120 may process information associated with comparing projection input. In some embodiments, one or more device control units 120 may process information associated with initiating an action in response to comparing. In some embodiments, a device control unit 120 may be operably associated with device processor memory 120B. Accordingly, in some embodiments, device processor memory 120B may include information associated with the operation of the device processor 120A. For example, in some embodiments, device processor memory 120B may include device processor instructions 120C. Device processor instructions 120C may include numerous types of instructions. For example, in some embodiments, device processor instructions 120C may instruct one or more device processors 120A to correlate one or more motions that are imparted to a device with one or more commands. In some embodiments, a device control unit 120 may be operably associated with device memory 120D. Device memory 120D may include numerous types of information. Examples of such information include, but are not limited to, pictures, text, internet addresses, maps, instructions, and the like. In some embodiments, device memory 120D may include device instructions 120E. For example, in some embodiments, device instructions 120E may instruct a device to pair a certain communications protocol with another device (e.g., use of Bluetooth to communicate with a laptop computer).

### Financial Entity

In some embodiments, system 100 may be configured to communicate with one or more financial entities 122. System 100 may be configured to communicate with numerous types of financial entities 122. Examples of such financial entities 122 include, but are not limited to, banks, credit unions, retail stores, credit card companies, issuers of prepaid service cards (e.g., prepaid telephone cards, prepaid internet cards, etc.). In some embodiments, a financial entity 122 may include a user account 124. Examples of such user accounts 124 include, but are not limited to, checking accounts, savings accounts, prepaid service accounts, credit card accounts, and the like.

### Financial Information

In some embodiments, system 100 may include financial information 126. For example, in some embodiments, system 100 may include memory 174 in which financial information 126 may be saved. In some embodiments, system 100 may include access to financial information 126. For example, in some embodiments, system 100 may include access codes that may be used to access financial information 126. In some embodiments, financial information 126 may include information about an individual (e.g., credit history, prepaid accounts, checking accounts, saving accounts, credit card accounts, and the like). In some embodiments, financial information 126 may include information about an institution (e.g., information about an institution that issues credit cards, prepaid service cards, automatic teller machine cards, and the like). Accordingly, in some embodiments, system 100 may be configured to allow a user 110 to access financial information 126 to pay for the use of system 100 or a component thereof. In some embodiments, financial information 126 may include financial transactions (e.g. funds transfers), financial reports (e.g. account statements), financial requests (e.g. credit checks), and the like. Numerous types of financial entities 122 may receive the transmitted financial information 126. The financial entity 122 may include banking systems, credit systems, online payment systems (e.g. PayPal®), bill processing systems, and the like. The financial entity 122 including a user account 124 may be maintained as a component of the service provider module 130 or as an independent service.

### Service Provider Module

In some embodiments, system 100 may be configured to communicate with one or more service provider modules 130. The service provider module 130 may be an integrated or distributed server system associated with one or more communications networks 128. Numerous types of communications networks 128 may be used. Examples of communications networks 128 may include, but are not limited to, a voice over internet protocol (VoIP) network (e.g. networks maintained by Vonage®, Verizon®, Sprint®), a cellular network (e.g. networks maintained by Verizon®, Sprint®, AT&T®, T-Mobile®), a text messaging network (e.g. an SMS system in GSM), an e-mail system (e.g. an IMAP, POP3, SMTP, and/or HTTP e-mail server), and the like.

The service provider module 130 may include one or more service provider receivers 132A. The service provider module 130 may include one or more service provider transmitters 132B. Numerous types of service provider receivers 132A and transmitters 132B may be used. Examples of service provider receivers 132A and transmitters 132B may include, but are not limited to, a cellular transceiver, a satellite transceiver, a network portal (e.g. a modem linked to an internet service provider), and the like.

The service provider module 130 may include a processor 134. Numerous types of processors 134 may be used (e.g. general purpose processors 134 such as those marketed by Intel® and AMD, application specific integrated circuits, and the like). For example, the processor 134 may include, but is not limited to, one or more logic blocks capable of performing one or more computational functions, such as user identification logic 136, user-authentication logic 138, billing logic 140, access logic 142, and the like.

The service provider module 130 may include provider memory 144. Numerous types of provider memory 144 may be used (e.g. RAM, ROM, flash memory, and the like). The provider memory 144 may include, but is not limited to, a user identification database 146 including user data 148 for one or more users 110. A user identification database 146 item for a user 110 may include one or more fields including identity authentication data 150.

The user data 148 may include data representing various identification characteristics of one or more users 110. The identification characteristics of the one or more users 110 may include, but are not limited to, user names, identification numbers, telephone numbers (e.g., area codes, international codes), images, voice prints, locations, ages, gender, physical trait, and the like.

### Sensor Control Unit

System 100 may include one or more sensor control units 154. In some embodiments, one or more sensor control units 154 may be operably associated with one or more sensors 156. In some embodiments, one or more sensor control units 154 may be operably associated with one or more sensor interface modules 158. In some embodiments, one or more sensor control units 154 may be operably associated with one or more sensor processors 154A. In some embodiments, one or more sensor control units 154 may be operably associated with sensor processor memory 154B. In some embodiments, one or more sensor control units 154 may be operably associated with one or more sensor processor instructions 154C. In some embodiments, one or more sensor control units 154 may be operably associated with sensor memory 154D. In some embodiments, one or more sensor control units 154 may be operably associated with one or more sensor instructions 154E. In some embodiments, one or more sensor control units 154 may facilitate the transmission of one or more signals 170 that include information associated with one or more changes in sensor 156 response. For example, in some embodiments, one or more signals 170 that include information associated with a change in one or more features associated with one or more projection surfaces 166 may be transmitted. The one or more signals 170 may be received by one or more projection control units 162 and used to facilitate projection by one or more projectors 164 in response to the one or more signals 170. In some embodiments, one or more sensor control units 154 may use prior sensor response, user input, or other stimulus, to activate or deactivate one or more sensors 156 or other subordinate features contained within one or more sensor control units 154.

### Sensor

System 100 may include one or more sensors 156. In some embodiments, one or more sensors 156 may be operably associated with one or more sensor control units 154. In some embodiments, one or more sensors 156 may be operably associated with one or more sensor interface modules 158. System 100 may include many types of sensors 156 alone or in combination. Examples of sensors 156 include, but are not limited to, 156P cameras, 156H light sensors, 156O range sensors, 156G contact sensors, 156K entity sensors, 156L infrared sensors, 156M yaw rate sensors, 156N ultraviolet sensors, 156E inertial sensors, 156F ultrasonic sensors, 156I imaging sensors, 156J pressure sensors, 156A motion sensors, 156B gyroscopic sensors, 156C acoustic sensors, 156D biometric sensors, and the like. In some embodiments, one or more sensors 156 may be configured to detect motion. In some embodiments, one or more sensors 156 may be configured to detect motion that is imparted to one or more projection surfaces 166. In some embodiments, one or more sensors 156 may be configured to detect the availability of one or more projection surfaces 166.

### Sensor Interface Module

System 100 may include one or more sensor interface modules 158. In some embodiments, one or more sensor interface modules 158 may be operably associated with one or more sensor control units 154. In some embodiments, one or more sensor interface modules 158 may be operably associated with one or more sensors 156. In some embodiments, one or more sensor interface modules 158 may be configured to communicate with one or more user device interfaces 114. In some embodiments, one or more sensor interface modules 158 may be configured to communicate with one or more projection interface modules 160. In some embodiments, one or more sensor interface modules 158 may be configured to communicate with one or more projection surface control units 179. A sensor interface module 158 may communicate with other components of system 100 through use of numerous communication formats and combinations of communication formats. Examples of such formats include, but are not limited to, 158A VGA, 158D USB, 158I wireless USB, 158B RS-232, 158E infrared, 158J Bluetooth, 158C 802.11b/g/n, 158F S-video, 158H Ethernet, 158G DVI-D, and the like. In some embodiments, a sensor interface module 158 may include one or more sensor transmitters 158K. In some embodiments, a sensor interface module 158 may include one or more sensor receivers 158L.

### Projection Control Unit

System 100 may include one or more projection control units 162. In some embodiments, one or more projection control units 162 may be operably associated with one or more projectors 164. In some embodiments, one or more projection control units 162 may be operably associated with one or more projection interface modules 160. In some embodiments, one or more projection control units 162 may be operably associated with one or more projectors 164 and one or more projection interface modules 160. In some embodiments, a projection control unit 162 may be operably associated with one or more projection processors 162A. In some embodiments, a projection control unit 162 may be operably associated with projection memory 162J. In some embodiments, a projection control unit 162 may be operably associated with one or more projection instructions 162I. In some embodiments, a projection control unit 162 may be operably associated with one or more projection control transmitters 162H. In some embodiments, a projection control unit 162 may be operably associated with one or more projection control receivers 162G. In some embodiments, a projection control unit 162 may be operably associated with one or more projection processors 162A that include projection logic 162B. Examples of such projection logic 162B include, but are not limited to, prioritization logic 162C (e.g., logic for prioritizing projection in response to one or more requests 168 from one or more specific individuals), scheduling logic 162D (e.g., logic for scheduling projection in response to the availability of one or more projectors 164, one or more projection surfaces 166, or the combination of one or more projectors 164 and one or more projection surfaces 166), selection logic 162E (e.g., logic for selecting content in response to one or more requests 168 from one or more specific individuals), projection logic 162B (e.g., logic for selecting projection parameters in response to one or more features associated with one or more projection surfaces 166), and the like. In some embodiments, a projection control unit 162 may be configured to modulate output projected by one or more projectors 164. In some embodiments, one or more projection control units 162 may be configured to select one or more wavelengths of light or intensities of light that will be projected by one or more projectors 164. For example, in some embodiments, one or more projection control units 162 may select one or more wavelengths of ultraviolet light that will be projected by one or more projectors 164. In some embodiments, one or more projection control units 162 may select one or more wavelengths of visible light that will be projected by one or more projectors 164. In some embodiments, one or more projection control units 162 may select one or more wavelengths of infrared light that will be projected by one or more projectors 164. Accordingly, in some embodiments, one or more projection control units 162 may select numerous wavelengths of light that will be projected by one or more projectors 164.

In some embodiments, one or more projection control units 162 may select content that is to be projected by one or more projectors 164. In some embodiments, one or more projection control units 162 may select content that is to be projected in response to one or more requests 168 from one or more users 110. For example, in some embodiments, one or more projection control units 162 may select content that is appropriate for children in response to a request 168 from a child. In some embodiments, one or more projection control units 162 may modulate output that is projected by one or more projectors 164. In some embodiments, one or more projection control units 162 may modulate the intensity of light that is projected by one or more projectors 164. In some embodiments, one or more projection control units 162 may modulate the brightness of light that is projected by one or more projectors 164. In some embodiments, one or more projection control units 162 may modulate the contrast of light that is projected by one or more projectors 164. In some embodiments, one or more projection control units 162 may modulate the sharpness of light that is projected by one or more projectors 164. In some embodiments, one or more projection control units 162 may modulate the movement of light that is projected by one or more projectors 164.

In some embodiments, one or more projection control units 162 may modulate the direction of output that is projected by one or more projectors 164. In some embodiments, one or more projection control units 162 may direct output from one or more projectors 164 onto one or more moving projection surfaces 166. In some embodiments, one or more projection control units 162 may direct output from one or more projectors 164 onto one or more stationary projection surfaces 166. In some embodiments, one or more projection control units 162 may direct output from one or more projectors 164 onto one or more moving projection surfaces 166 and onto one or more stationary projection surfaces 166. In some embodiments, one or more projection control units 162 may direct output from one or more projectors 164 onto multiple projection surfaces 166. For example, in some embodiments, one or more projection control units 162 may direct output from one or more projectors 164 onto a first projection surface 166 and direct output from one or more projectors 164 onto a second projection surface 166.

In some embodiments, one or more projection control units 162 may direct output from two or more projectors 164 in a coordinated manner. For example, in some embodiments, one or more projection control units 162 may coordinate output from two or more projectors 164 onto the same projection surface 166. In some embodiments, one or more projection control units 162 may coordinate output from two or more projectors 164 onto one or more projection surfaces 166. In some embodiments, one or more projection control units 162 may coordinate output of content from two or more projectors 164. For example, in some embodiments, one or more projection control units 162 may coordinate projection of a first set of content from a first projector 164 and projection of a second set of content from a second projector 164. Accordingly, in some embodiments, one or more projection control units 162 may coordinate projection of content in accordance with the type of content that is projected. For example, in some embodiments, a high resolution projector may be used to project high resolution content and a low resolution projector may be used to project low resolution content in a coordinated manner. In some embodiments, one or more projection control units 162 may coordinate the projection of three-dimensional images (e.g., isometric projection, oblique projection, cavalier projection, one-point perspective projection). Accordingly, numerous methods may be used to coordinate projection from two or more projectors 164. For example, tiling may be used to coordinate projection from two or more projectors 164 (e.g., Christie Digital Systems USA, Inc., Cypress, Calif.).

In some embodiments, one or more projection control units 162 may dynamically modulate output from one or more projectors 164. For example, in some embodiments, one or more projectors 164 may be carried from room to room such that one or more projection control units 162 modulate output from the one or more projectors 164 in response to the available projection surface 166. In some embodiments, one or more projection control units 162 may dynamically modulate output from two or more projectors 164.

In some embodiments, one or more projection control units 162 may be configured to respond to one or more substantially defined motions. In some embodiments, a user 110 may program one or more projection control units 162 to correlate one or more substantially defined motions with one or more projection commands. For example, in some embodiments, a user 110 may program one or more projection control units 162 to correlate clockwise motion of a user communications device 112 with a command to advance a projected slide presentation by one slide. Accordingly, in some embodiments, a projection control unit 162 may be configured to project in response to substantially defined motions that are programmed according to the preferences of an individual user 110.

In some embodiments, one or more projection control units 162 may direct output from two or more sources from one or more projectors 164. In some embodiments, one or more projection control units 162 may direct output from two or more sources on the same projection surface 166. In some embodiments, one or more projection control units 162 may direct output from two or more sources on one or more projection surfaces 166. For example, sources may include a user communications device 112, a network file location, a computer readable media, user input, or an interne file.

In some embodiments, one or more projection control units 162 may direct output from one or more projectors 164 in coordination with audio content (e.g. music, verbal communications, recording, or soundtrack). In some embodiments, sources of audio content include a user communications device 112, a network file location, a computer readable media, user input, an internet file, or from live or recorded verbal communications proximate to one or more projection surfaces 166.

### Projector

System 100 may include one or more projectors 164. In some embodiments, a projector 164 may be a user responsive projector 164 that is configured to project for an individual user 110 in an individualized manner. In some embodiments, a user responsive projector 164 may be configured to be controllable by an individual user 110 and/or group of users 110. For example, in some embodiments, a user responsive projector 164 may be directed to project onto one or more projection surfaces 166 that are selected by a user 110. Accordingly, in some embodiments, numerous functions of a user responsive projector 164 may be controlled by a user 110 in an individualized manner.

In some embodiments, a projector 164 may be operably associated with one or more projection control units 162. In some embodiments, a projector 164 may be operably associated with one or more projection interface modules 160. In some embodiments, a projector 164 may be operably associated with one or more projection processors 162A. In some embodiments, a projector 164 may be operably associated with projection memory 162J. In some embodiments, a projector 164 may be operably associated with one or more projection instructions 162I. In some embodiments, a projector 164 may be operably associated with projection logic 162B. In some embodiments, a projector 164 may be an image stabilized projector 164. In some embodiments, two or more projectors 164 may be configured for coordinated projection. For example, in some embodiments, two or more projectors 164 may be positioned to project onto the same projection surface 166. In some embodiments, two or more projectors 164 may be configured for tiled projection of content.

System 100 may include numerous types of projectors 164. In some embodiments, a projector 164 may include inertia and yaw rate sensors that detect motion and provide for adjustment of projected content to compensate for the detected motion. In some embodiments, a projector 164 may include an optoelectronic inclination sensor and an optical position displacement sensor to provide for stabilized projection (e.g., U.S. Published Patent Application No.: 2003/0038927). In some embodiments, a projector 164 may include an optoelectronic inclination sensor, an optical position sensitive detector, and a piezoelectric accelerometer that provide for stabilized projection (e.g., U.S. Published Patent Application No.: 2003/0038928). Image stabilized projectors 164 have been described (e.g., U.S. Pat. No. 7,284,866; U.S. Published Patent Application Nos.: 20050280628; 20060103811, and 2006/0187421). In some embodiments, one or more projectors 164 may be modified to become image stabilized projectors 164. Examples of such projectors 164 have been described (e.g., U.S. Pat. Nos. 6,002,505; 6,764,185; 6,811,264; 7,036,936; 6,626,543; 7,134,078; 7,355,584; U.S. Published Patent Application No.: 2007/0109509).

Projectors 164 may be configured to project numerous wavelengths of light. In some embodiments, a projector 164 may be configured to project ultraviolet light. In some embodiments, a projector 164 may be configured to project visible light. In some embodiments, a projector 164 may be configured to project infrared light. In some embodiments, a projector 164 may be configured to project numerous combinations of light. For example, in some embodiments, a projector 164 may project one or more infrared calibration images and one or more visible images.

Numerous types of projectors 164 may be used within system 100. In some embodiments, analog projectors 164 may be used within system 100. In some embodiments, digital projectors 164 may be used within system 100. In some embodiments, combinations of projector 164 types may be used within system 100. In some embodiments, pico-projectors 164 may be used within system 100 (e.g., Texas Instruments, Dallas, Tex.; Microvision, Redmond, Wash.; Toshiba, New York, N.Y.; WowWee Group Limited, Carlsbad, Calif.). Numerous configurations of projectors 164 may be used within system 100. In some embodiments, projectors 164 may be mounted within a venue. For example, in some embodiments, one or more projectors 164 may be mounted within a venue on walls, ceilings, floors, dividers, furniture, etc. Accordingly, in some embodiments, a user 110 may enter into a venue and utilize one or more projectors 164 that are present at a venue. In some embodiments, system 100 may include projectors 164 that are portable. In some embodiments, a venue may include portable projectors 164 that are operable within system 100. For example, in some embodiments, a user 110 may enter a venue and obtain a projector 164 (e.g., rent a projector 164, borrow a projector 164) that may be operably connected for use within system 100. Accordingly, in some embodiments, a user 110 may take one or more projectors 164 to substantially any accessible location within a venue and utilize the one or more projectors 164 to project material onto substantially any projection surface 166 that is available for projection. Accordingly, system 100 may be configured to utilize numerous types of projectors 164.

### Projection Interface Module

System 100 may include one or more projection interface modules 160. In some embodiments, one or more projection interface modules 160 may be operably associated with one or more projection control units 162. In some embodiments, one or more projection interface modules 160 may be operably associated with one or more projectors 164. A projection interface module 160 may communicate with other components of system 100 through use of numerous communication formats and combinations of communication formats. Examples of such formats include, but are not limited to, 160A VGA, 160D USB, 160I wireless USB, 160B RS-232, 160E infrared, 160J Bluetooth, 160C 802.11b/g/n, 160F S-video, 160H Ethernet, 160G DVI-D, and the like. In some embodiments, a projection interface module 160 may include one or more projection transmitters 160K. In some embodiments, a projection interface module 160 may include one or more projection receivers 160L.

### Projection Surface

System 100 may include one or more projection surfaces 166. In some embodiments, one or more projection surfaces 166 are operably associated with one or more benchmark comparing modules 172. In some embodiments, one or more projection surfaces 166 are operably associated with one or more memory 174. In some embodiments, one or more projection surfaces 166 are operably associated with one or more projection surface control units 179. In some embodiments, one or more projection surfaces 166 are operably associated with one or more device interface modules 176. In some embodiments, one or more projection surfaces 166 are operably associated with one or more user interfaces 178. In some embodiments, one or more projection surfaces 166 are operably associationed with a housing 180.

In some embodiments, one or more projection surfaces 166 are configured to receive projection input from one or more projectors 164. In some embodiments, one or more projection surfaces 166 are configured to receive user input. In some embodiments, one or more projection surfaces 166 are configured to receive content from at least one other source (e.g., a file location, an interne address, a device). In some embodiments, one or more projection surfaces 166 are configured to receive audio content.

In some embodiments, one or more projection surfaces 166 are configured as a portable tablet. In some embodiments, one or more projection surfaces 166 are configured as a sheet of material or two or more sheets of material that may be separated from each other, and the like. In some embodiments, one or more projection surfaces 166 are configured as a writing surface. In some embodiments, one or more projection surfaces 166 are configured as a hanging or mountable device. In some embodiments, one or more projection surfaces 166 are configured as a surface on a vehicle console.

One or more projection surfaces 166 may be constructed from numerous types of materials and combinations of materials. In some embodiments, one or more projection surfaces 166 may be constructed from glass or plastic 166A. Examples of other materials include, but are not limited to, cloth, metal, ceramics, paper, wood, leather, and the like. In some embodiments, one or more projection surfaces 166 may exhibit electrochromic properties. In some embodiments, one or more projection surfaces 166 may be coated with a coating 166B. In some embodiments, coating 166B may include a transmissive coating 166C. In some embodiments, coating 166B may include a reflective coating 166D. In some embodiments, coating 166B may include a refractive coating 166E. In some embodiments, a projection surface 166 may be coated with paint. In some embodiments, a projection surface 166 may include one or more materials that alter light. For example, in some embodiments, a projection surface 166 may convert light (e.g., up-convert light, down-convert light).

In some embodiments, a projection surface 166 may be operably associated with one or more surface sensors. In some embodiments, a projection surface 166 may include one or more magnetic surface sensors. For example, in some embodiments, a projection surface 166 may include magnetic surface sensors that are configured to detect magnetic ink that is applied to the projection surface 166. In some embodiments, a projection surface 166 may include one or more pressure surface sensors. For example, in some embodiments, a projection surface 166 may include pressure surface sensors that are configured to detect pressure that is applied to the projection surface 166 (e.g., contact of a stylus with the projection surface 166, contact of a pen with the projection surface 166, contact of a pencil with the projection surface 166, etc.). In some embodiments, a projection surface 166 may include one or more motion surface sensors. For example, in some embodiments, a projection surface 166 may include motion surface sensors that are configured to detect movement associated with the projection surface 166. In some embodiments, a projection surface 166 may include one or more strain surface sensors. For example, in some embodiments, a projection surface 166 may include strain surface sensors that are configured to detect changes in conformation associated with the projection surface 166. In some embodiments, a projection surface 166 may include one or more positional surface sensors (e.g., global positioning surface sensors). For example, in some embodiments, a projection surface 166 may include positional surface sensors that are configured to detect changes in position associated with the projection surface 166.

In some embodiments, a projection surface 166 may be operably associated with one or more surface transmitters. Accordingly, in some embodiments, a projection surface 166 may be configured to transmit one or more signals 170. Such signals 170 may include numerous types of information. Examples of such information may include, but are not limited to, information associated with: one or more positions of one or more projection surfaces 166, one or more conformations of one or more projection surfaces 166, one or more changes in the position of one or more projection surfaces 166, one or more changes in the conformation of one or more projection surfaces 166, one or more motions associated with one or more projection surfaces 166, one or more changes in the motion of one or more projection surfaces 166, and the like.

In some embodiments, a projection surface 166 may be operably associated with one or more surface receivers. Accordingly, in some embodiments, a projection surface 166 may be configured to receive one or more signals 170. For example, in some embodiments, one or more surface receivers may receive one or more signals 170 that are transmitted by one or more projection transmitters 160K. In some embodiments, one or more surface receivers may receive one or more signals 170 that are transmitted by one or more sensor transmitters 158K.

In some embodiments, a projection surface 166 may be operably associated with one or more fiducials. For example, in some embodiments, one or more fluorescent marks may be placed on a projection surface 166. In some embodiments, one or more phosphorescent marks may be placed on a projection surface 166. In some embodiments, one or more magnetic materials may be placed on a projection surface 166. In some embodiments, fiducials may be placed on a projection surface 166 in numerous configurations. For example, in some embodiments, fiducials may be positioned in association with a projection surface 166 such that they form a pattern. In some embodiments, a projection surface 166 may include one or more calibration images.

### Projection Surface Control Unit

In some embodiments, one or more projection surface control units 179 may be operably associated with one or more projection surfaces 166. In some embodiments, one or more projection surface control units 179 may be operably associated with one or more benchmark comparing modules 172. In some embodiments, one or more projection surface control units 179 may be operably associated with one or more memory 174. In some embodiments, one or more projection surface control units 179 may be operably associated with one or more device interface modules 176. In some embodiments, one or more projection surface control units 179 may be operably associated with one or more user interfaces 178. In some embodiments, one or more projection surface control units 179 may be operably associated with one or more surface processors 179A. In some embodiments, one or more projection surface control units 179 may be operably associated with one or more surface processor memory 179B. In some embodiments, one or more projection surface control units 179 may be operably associated with one or more surface processor instructions 179C. In some embodiments, one or more projection surface control units 179 may be operably associated with one or more surface memory 179D. In some embodiments, one or more projection surface control units 179 may be operably associated with one or more surface instructions 179E.

In some embodiments, a projection surface control unit 179 is configured to operably communicate with one or more projectors 164. In some embodiments, a projection surface control unit 179 is configured to operably communicate with one or more sensors 156. In some embodiments, a projection surface control unit 179 is configured to operably communicate with one or more service provider modules 130. In some embodiments, a projection surface control unit 179 is configured to operably communicate with one or more financial entities 122. In some embodiments, a projection surface control unit 179 is configured to operably communicate with one or more user communications devices 112. In some embodiments, a projection surface control unit 179 is configured to operably communicate with one or more users 110.

In some embodiments, a projection surface control unit 179 may be configured to control receiving projection input with one or more projection surfaces 166. In some embodiments, a projection surface control unit 179 may be configured to control one or more benchmark comparing modules 172. For example, a projection surface control unit 179 may be configured to control comparing one or more projection inputs with one or more benchmarks. In some embodiments, a projection surface control unit 179 may be configured to control initiating an action in response to comparing one or more projection inputs with one or more benchmarks. In some embodiments, a projection surface control unit 179 may be configured to control communications via one or more user interfaces 178. For example, in some embodiments, a projection surface control unit 179 may be configured to provide a graphical user interface 178, accept user commands and requests 168, and provide output via one or more user interfaces 178. In some embodiments, a projection surface control unit 179 may be configured to control communications via one or more device interface modules 176. For example, in some embodiments, a projection surface control unit 179 may be configured to receive commands, transmit commands, receive data, and transmit data via one or more device interface modules 176. In some embodiments, a projection surface control unit 179 may be configured to control communication via one or more communications networks 128. In some embodiments, a projection surface control unit 179 may be configured to control one or more projection surfaces 166. For example, in some embodiments, a projection surface control unit 179 may be configured to control light transmission, refraction, reflection, brightness, contrast, resolution, or colors on one or more projection surfaces 166. In some embodiments, a projection surface control unit 179 may be configured to control placement or power for one or more projection surfaces 166. In some embodiments, a projection surface control unit 179 may be configured to control one or more memory 174. For example, a projection surface control unit 179 may be configured to facilitate storage and retrieval of data and commands from one or more memory 174. In some embodiments, a projection surface control unit 179 may be configured to control timing, volume, location, source, destination, or association of audio or data capture.

### Benchmark Comparing Module

In some embodiments, one or more benchmark comparing modules 172 may be operably associated with one or more projection surfaces 166. In some embodiments, one or more benchmark comparing modules 172 may be operably associated with one or more memory 174. In some embodiments, one or more benchmark comparing modules 172 may be operably associated with one or more projection surface control units 179. In some embodiments, one or more benchmark comparing modules 172 may be operably associated with one or more user interfaces 178. In some embodiments, one or more benchmark comparing modules 172 may be operably associated with one or more device interface modules 176. In some embodiments, one or more benchmark comparing modules 172 may be operably associated with one or more processors 172A. In some embodiments, one or more benchmark comparing modules 172 may be operably associated with one or more processor memory 172B. In some embodiments, one or more benchmark comparing modules 172 may be operably associated with one or more processor instructions 172C. In some embodiments, one or more benchmark comparing modules 172 may be operably associated with one or more memory 172D. In some embodiments, one or more benchmark comparing modules 172 may be operably associated with one or more instructions 172E.

In some embodiments, one or more benchmark comparing modules 172 may be configured to receive projection input using full imaging through a CCD array, a CID array, or photodiode array. In some embodiments, one or more benchmark comparing modules 172 may be configured to receive projection input using optical scanning through a CCD array, a CID array, or photodiode array; one or more drive mechanisms; and one or more optics such as a flat mirror, a parabolic mirror, or a lens. In some embodiments, one or more benchmark comparing modules 172 may be configured to receive projection input using mechanical scanning through a CCD array, a CID array, or photodiode array and one or more drive mechanisms.

In some embodiments, one or more benchmark comparing modules 172 may be configured to receive projection input from one or more projection surfaces 166. For example, in some embodiments, one or more benchmark comparing modules 172 may be configured to receive as projection input an image, a series of images, a video, audio, data, or user input from one or more projection surfaces 166. In some embodiments, one or more benchmark comparing modules 172 may be configured to receive projection input from two or more projection surfaces 166. For example, in some embodiments, one or more benchmark comparing modules 172 may be configured to receive one projection input from one projection surface 166 and a same or different projection input from another projection surface 166. In some embodiments, one or more benchmark comparing modules 172 may be configured to receive projection input from another source. For example, in some embodiments, one or more benchmark comparing modules 172 may be configured to receive projection input from a network location, memory 174, a projector 164, the interne, or a user communications device 112.

### Memory

In some embodiments, one or more memory 174 (e.g., RAM, ROM, flash memory and the like) may be operably associated with one or more projection surfaces 166. In some embodiments, one or more memory 174 may be operably associated with one or more benchmark comparing modules 172. In some embodiments, one or more memory 174 may be operably associated with one or more projection surface control units 179. In some embodiments, one or more memory 174 may be operably associated with one or more device interface modules 176. In some embodiments, one or more memory 174 may be operably associated with one or more user interfaces 178.

In some embodiments, memory 174 may be configured to store images, video, audio, content from other sources, references, user inputs, or other data. In some embodiments, memory 174 may be configured to store program instructions for one or more projection surfaces 166, one or more benchmark comparing modules 172, a projection surface control unit 179, a device interface module 176, or a user interface 178.

### Device Interface Module

In some embodiments, one or more device interface modules 176 may be operably associated with one or more projection surfaces 166. In some embodiments, one or more device interface modules 176 may be operably associated with one or more benchmark comparing modules 172. In some embodiments, one or more device interface modules 176 may be operably associated with one or more memory 174. In some embodiments, one or more device interface modules 176 may be operably associated with one or more projection surface control units 179. In some embodiments, one or more device interface modules 176 may be operably associated with one or more user interfaces 178.

In some embodiments, one or more device interface modules 176 may be configured to operably communicate with one or more user communications devices 112. In some embodiments, one or more device interface modules 176 may be configured to operably communicate with one or more financial entities 122. In some embodiments, one or more device interface modules 176 may be configured to operably communicate with one or more service provider modules 130. In some embodiments, one or more device interface modules 176 may be configured to operably communicate with one or more projectors 164. In some embodiments, one or more device interface modules 176 may be configured to operably communicate with one or more sensors 156. One or more device interface modules 176 may communicate with other components of system 100 through use of numerous communication formats and combinations of communication formats using one or more projection surface transmitters 176N and/or one or more projection surface receivers 176O. Examples of such formats include, but are not limited to, 176A VGA, 176B RS-232, 176C 802.11b/g/n, 176D HDMI, 176E Component Video, 176F USB, 176G Infrared, 176H S-Video, 176I DVI-D, 176J Ethernet, 176K Cellular, 176L Wireless USB, 176M Bluetooth, and the like.

In some embodiments, one or more device interface modules 176 may be configured to receive commands, selections, or input for controlling one or more projection surfaces 166, one or more benchmark comparing modules 172, one or more memory 174, one or more projection surface control units 179, or one or more device interface modules 176. In some embodiments, one or more user interfaces 178 may be configured to transfer data, images, video, audio, or options for interacting with or receiving results from one or more projection surfaces 166, one or more benchmark comparing modules 172, one or more memory 174, one or more projection surface control units 179, or one or more device interface modules 176.

### User Interface

In some embodiments, one or more user interfaces 178 may be operably associated with one or more projection surfaces 166. In some embodiments, one or more user interfaces 178 may be operably associated with one or more benchmark comparing modules 172. In some embodiments, one or more user interfaces 178 may be operably associated with one or more memory 174. In some embodiments, one or more user interfaces 178 may be operably associated with one or more projection surface control units 179. In some embodiments, one or more user interfaces 178 may be operably associated with one or more device interface modules 176.

In some embodiments, one or more user interfaces 178 may be configured to operably communicate with one or more users 110. In some embodiments, one or more user interfaces 178 may be configured to operably communicate with one or more user communications devices 112. In some embodiments, one or more user interfaces 178 may be configured to operably communicate with one or more financial entities 122. In some embodiments, one or more user interfaces 178 may be configured to operably communicate with one or more service provider modules 130. In some embodiments, one or more user interfaces 178 may be configured to operably communicate with one or more sensors 156. In some embodiments, one or more user interfaces 178 may be configured to operably communicate with one or more projectors 164. In some embodiments, one or more user interfaces 178 may be configured to operably communicate via one or more communications networks 128.

In some embodiments, one or more user interfaces 178 may be configured as mechanical 178A (e.g., buttons, switches, keys, electromechanical etc.). In some embodiments, one or more user interfaces 178 may be configured as electronic 178B (touch screen, audible control, wireless communication, electronic communication, etc). In some embodiments, one or more user interfaces 178 may include one or more sensors 178C. For example, in some embodiments, one or more sensors 178C may include one or more motion sensors 178D, one or more gyroscopic sensors 178E, one or more acoustic sensors 178F, one or more biometric sensors 178G, one or more inertial sensors 178H, one or more ultrasonic sensors 178I, one or more contact sensors 178J, one or more light sensors 178K, one or more imaging sensors 178L, one or more pressure sensors 178M, one or more entity sensors 178N, one or more infrared sensors 178O, one or more yaw rate sensors 178P, one or more ultraviolet sensors 178Q, one or more range sensors 178R, or one or more cameras 178S.

In some embodiments, one or more user interfaces 178 may be configured to receive user commands, selections, or input for controlling one or more projection surfaces 166, one or more benchmark comparing modules 172, one or more memory 174, one or more projection surface control units 179, or one or more device interface modules 176. In some embodiments, one or more user interfaces 178 may be configured to present graphical user interfaces, images, video, audio, or options for interacting with or receiving results from one or more projection surfaces 166, one or more benchmark comparing modules 172, one or more memory 174, one or more projection surface control units 179, or one or more device interface modules 176.

### Request

Numerous types of requests 168 may be used in association with system 100. In some embodiments, a request 168 may include unprocessed input. In some embodiments, a request 168 may include unprocessed output. In some embodiments, a request 168 may include processed input. In some embodiments, a request 168 may include processed output. For example, in some embodiments, a user communications device 112 may receive unprocessed input from one or more users 110 and then process the input to produce a request 168 that includes the processed output. In some embodiments, a user communications device 112 may receive unprocessed input from one or more users 110 and then produce a request 168 that includes the unprocessed input that was received from the one or more users 110. In some embodiments, a user communications device 112 may receive processed input (e.g., from a user device interface 114, a user device interface module 116, a device sensor 118, a device control unit 120, and substantially any combination thereof) and then produce a request 168 that includes processed output. In some embodiments, a request 168 may include instructions. For example, in some embodiments, a request 168 may include projection instructions 162I. In some embodiments, a request 168 may include instructions to access one or more financial entities 122. In some embodiments, a request 168 may include instructions to communicate with one or more service provider modules 130. In some embodiments, a request 168 may include instructions to receive or compare projection input or to initiate an action in response to comparing projection input with one or more benchmarks. Accordingly, a request 168 may be configured in numerous ways and include numerous types of information.

### Signal

Numerous types of signals 170 may be used in association with system 100. Examples of such signals 170 include, but are not limited to, analog signals 170, digital signals 170, acoustic signals 170, optical signals 170, radio signals 170, wireless signals 170, hardwired signals 170, infrared signals 170, ultrasonic signals 170, Bluetooth signals 170, 802.11 signals 170, and the like. In some embodiments, one or more signals 170 may not be encrypted. In some embodiments, one or more signals 170 may be encrypted. In some embodiments, one or more signals 170 may be authenticated. In some embodiments, one or more signals 170 may be sent through use of a secure mode of transmission. In some embodiments, one or more signals 170 may be coded for receipt by a specific recipient. In some embodiments, such code may include anonymous code that is specific for the recipient. Accordingly, information included within one or more signals 170 may be protected against being accessed by others who are not the intended recipient. In some embodiments, one or more signals 170 may include information as one or more content packets.

In some embodiments, one or more signals 170 may include processed information. In some embodiments, one or more signals 170 may include information that has been processed by one or more sensor processors 154A. For example, in some embodiments, a sensor processor 154A may receive input from one or more sensors 156 that is processed. In some embodiments, this processed information may then be included within a signal 170 that is transmitted. In some embodiments, one or more signals 170 may include processed information that contains information that has been retrieved from sensor processor memory 154B. In some embodiments, one or more signals 170 may include processed information that contains information that has been processed through use of sensor processor instructions 154C. Accordingly, in some embodiments, one or more signals 170 may include numerous types of information that is processed. Examples of such processing may include, but are not limited to, sub-setting, generating projection commands, selecting content, selecting content for projection, selecting content that is not for projection, summarizing sensor data, transforming sensor data, supplementing sensor data, supplementing sensor data with data from external sources, generating projection input commands, generating image communication commands, and the like.

In some embodiments, one or more signals 170 may include information that has not been processed. In some embodiments, a sensor transmitter 158K may act as a conduit to transmit one or more signals 170 that include raw data. For example, in some embodiments, one or more sensor transmitters 158K may receive information from one or more sensors 156 and transmit one or more signals 170 that include the unprocessed information. Accordingly, in some embodiments, one or more signals 170 may include unprocessed information.

### User

System 100 may be operated by one or more users 110. In some embodiments, a user 110 may be human. In some embodiments, a user 110 may be a non-human user 110. For example, in some embodiments, a user 110 may be a computer, a robot, and the like. In some embodiments, a user 110 may be proximate to system 100. In some embodiments, a user 110 may be remote from system 100. In some embodiments, a user 110 may be an individual.

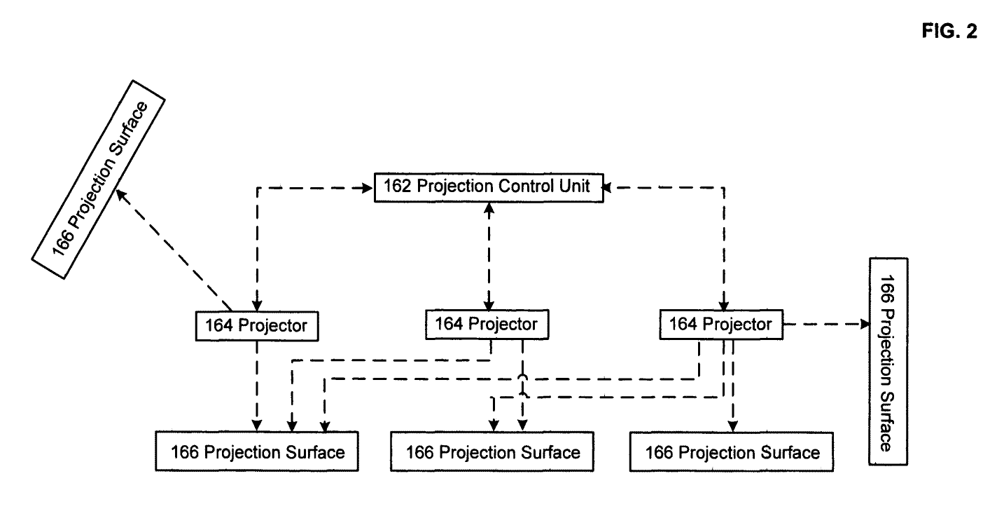

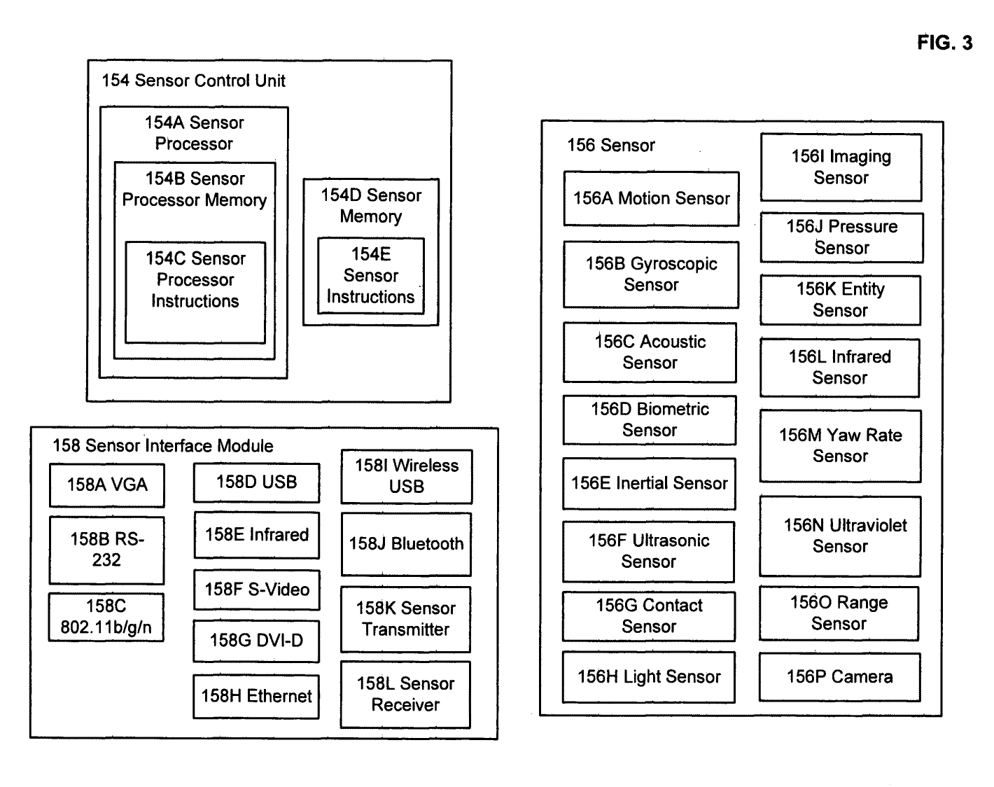

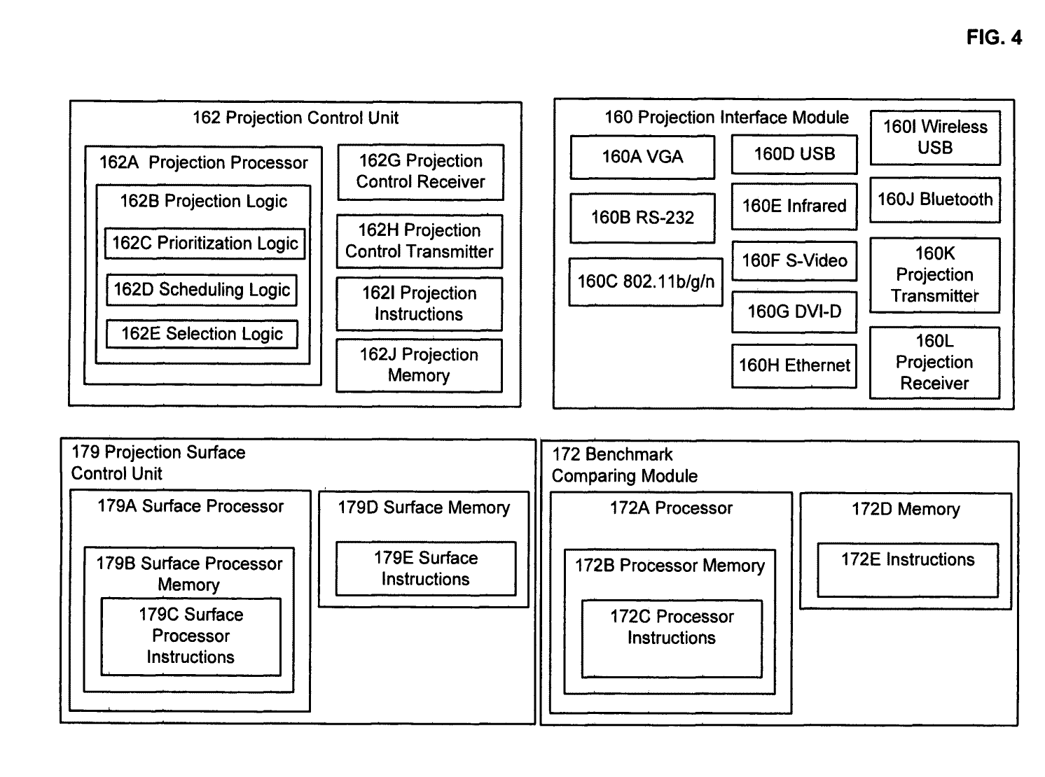

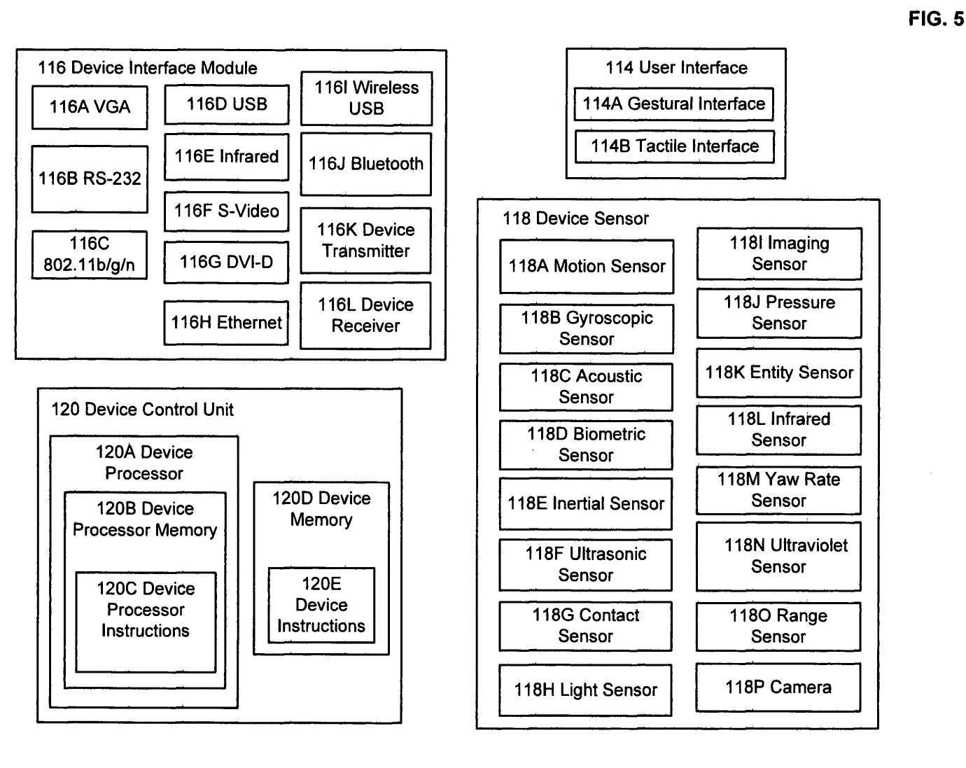

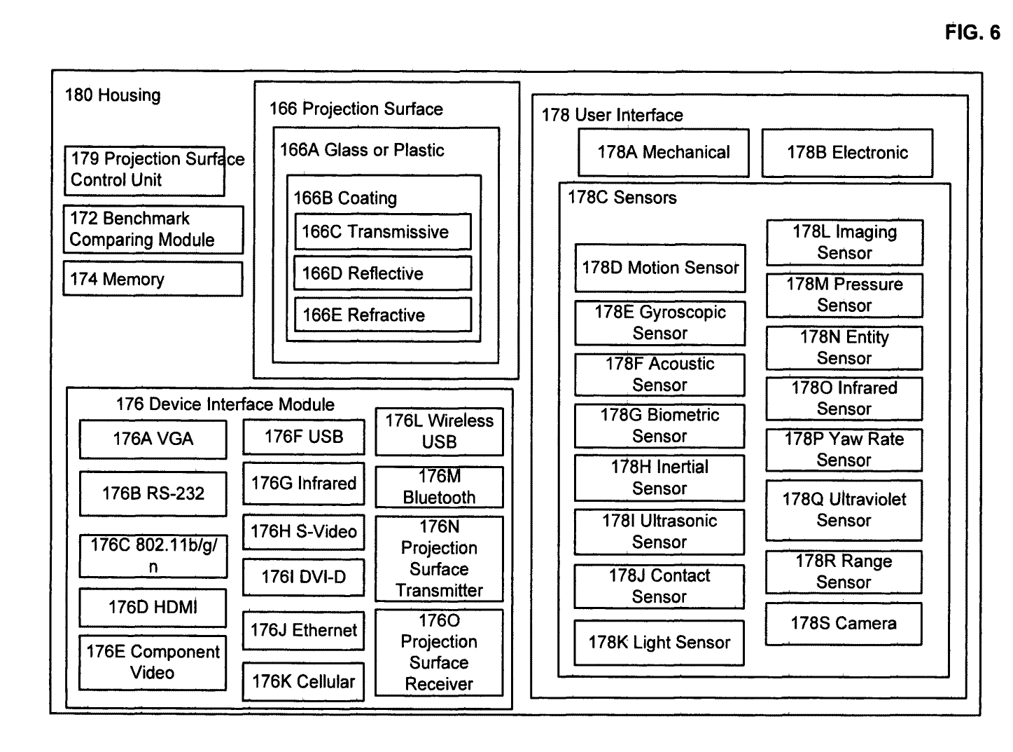

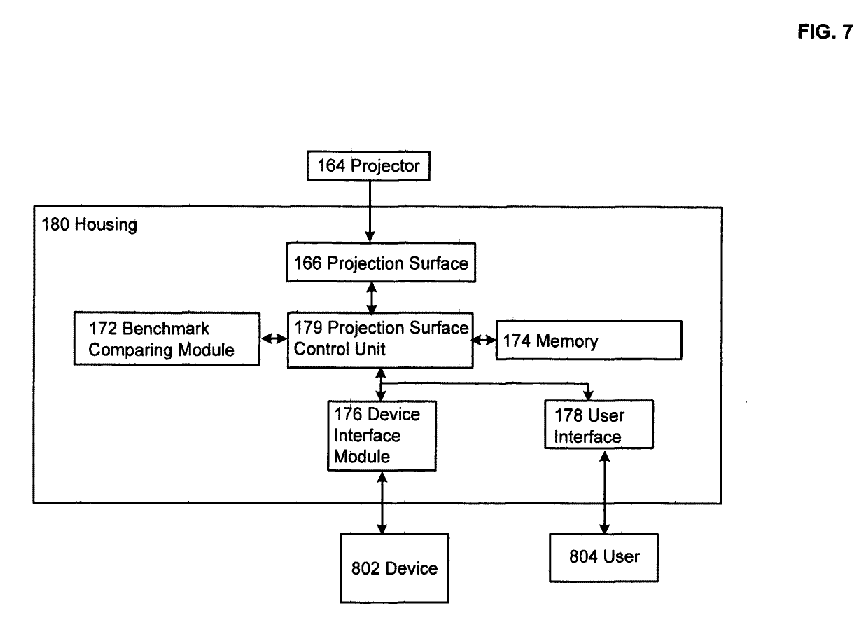

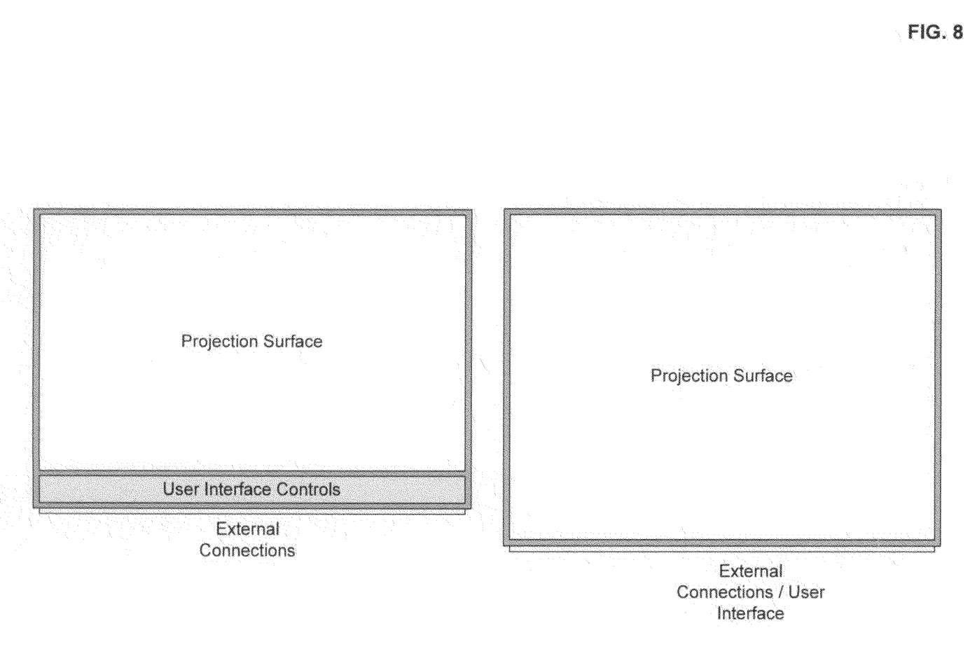

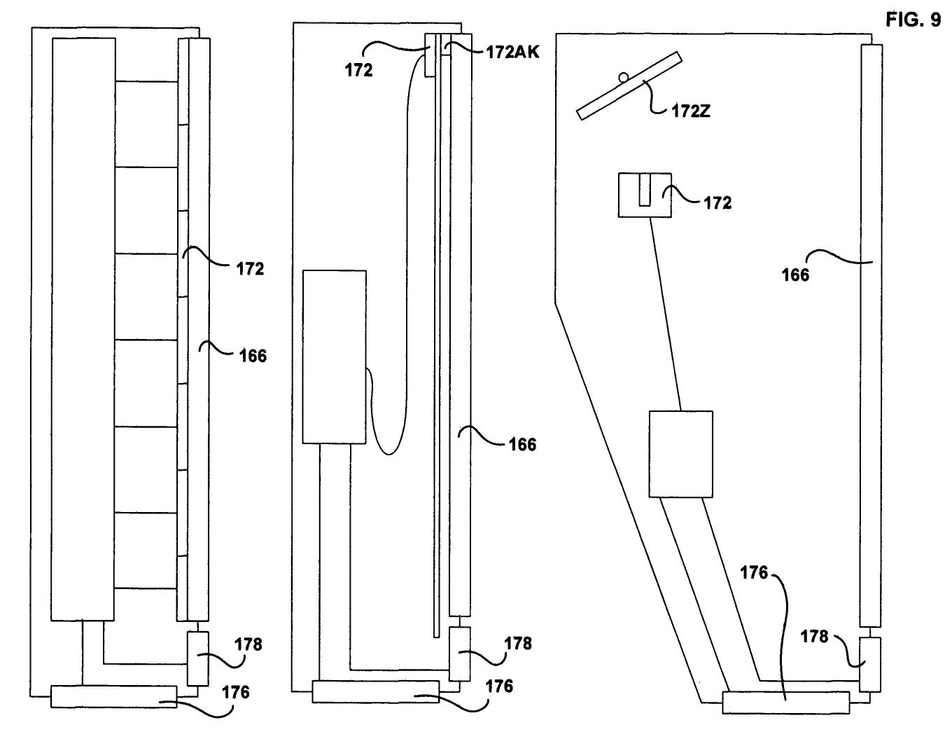

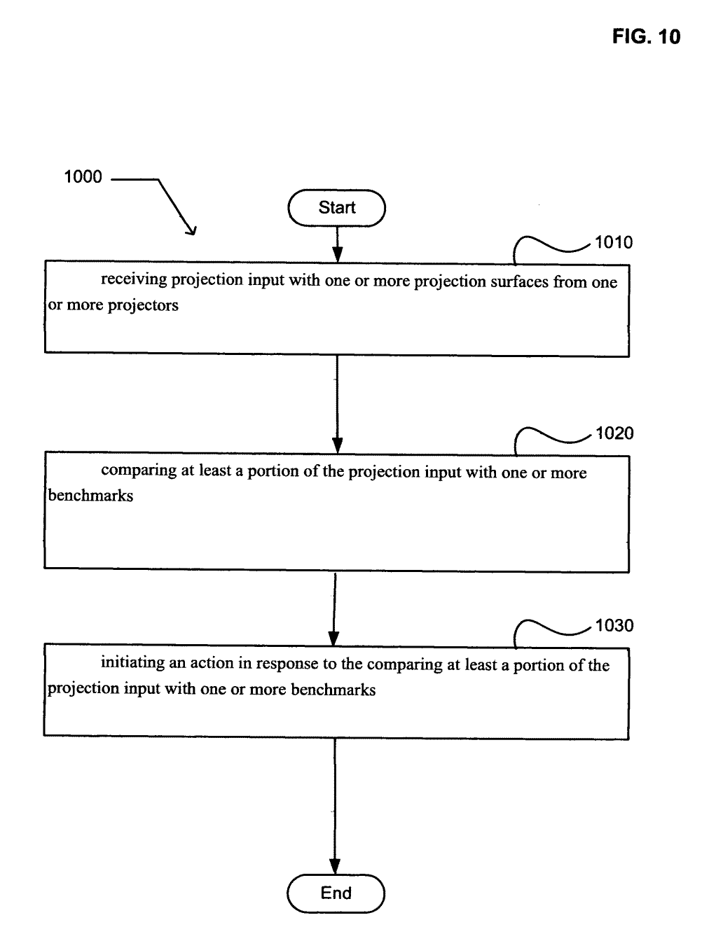

In FIG. 10 and in following figures that include various examples of operations used during performance of various methods, discussion and explanation may be provided with respect to any one or combination of the above-described examples of FIGS. 1-9, and/or with respect to other examples and contexts. However, it should be understood that the operations may be executed in a number of other environments and contexts, and/or modified versions of FIGS. 1-9. Also, although the various operations are presented in the sequence(s) illustrated, it should be understood that the various operations may be performed in other orders than those which are illustrated, or may be performed concurrently.

After a start operation, the operational flow 1000 includes a receiving operation 1010 involving receiving projection input with one or more projection surfaces from one or more projectors. In some embodiments, one or more projection surfaces 166 may receive projection input with one or more projection surfaces 166 from one or more projectors 164. In some embodiments, one or more projection surfaces 166 may receive projection input with one or more projection surfaces 166 from one or more portable projectors 164. In some embodiments, one or more projection surfaces 166 may receive projection input with one or more projection surfaces 166 from one or more projectors 164 in accordance with one or more user attributes. In some embodiments, one or more projection surfaces 166 may receive projection input with one or more projection surfaces 166 from one or more projectors 164 in accordance with one or more financial transactions. In some embodiments, one or more projection surfaces 166 may receive projection input with one or more projection surfaces 166 from one or more projectors 164 in accordance with one or more proximity determinations. In some embodiments, one or more projection surfaces 166 may receive projection input as one or more shape patterns of radiation with one or more projection surfaces 166 from one or more projectors 164. In some embodiments, one or more projection surfaces 166 may receive projection input as one or more frequency patterns of radiation with one or more projection surfaces 166 from one or more projectors 164. In some embodiments, one or more projection surfaces 166 may receive projection input as one or more intensity patterns of radiation with one or more projection surfaces 166 from one or more projectors 164. In some embodiments, one or more projection surfaces 166 may receive projection input as one or more temporal patterns of radiation with one or more projection surfaces 166 from one or more projectors 164. In some embodiments, one or more projection surfaces 166 may receive projection input as one or more selectively placed patterns of radiation with one or more projection surfaces 166 from one or more projectors 164. In some embodiments, one or more projection surfaces 166 may receive projection input as one or more dynamically altered patterns of radiation with one or more projection surfaces 166 from one or more projectors 164. In some embodiments, one or more projection surfaces 166 may receive projection input with one or more projection surfaces 166 from one or more projectors 164 in addition to user input.

After a start operation, the operational flow 1000 includes a comparing operation 1020 involving comparing at least a portion of the projection input with one or more benchmarks. In some embodiments, one or more benchmark comparing modules 172 may compare at least a portion of the projection input with one or more benchmarks. In some embodiments, one or more benchmark comparing modules 172 may compare at least a portion of the projection input with one or more pre-defined shape patterns of radiation benchmarks. In some embodiments, one or more benchmark comparing modules 172 may compare at least a portion of the projection input with one or more pre-defined frequency patterns of radiation benchmarks. In some embodiments, one or more benchmark comparing modules 172 may compare at least a portion of the projection input with one or more pre-defined intensity patterns of radiation benchmarks. In some embodiments, one or more benchmark comparing modules 172 may compare at least a portion of the projection input with one or more pre-defined temporal patterns of radiation benchmarks. In some embodiments, one or more benchmark comparing modules 172 may compare at least a portion of the projection input with one or more pre-defined selectively placed patterns of radiation benchmarks. In some embodiments, one or more benchmark comparing modules 172 may compare at least a portion of the projection input with one or more pre-defined dynamically altered patterns of radiation benchmarks. In some embodiments, one or more benchmark comparing modules 172 may compare at least a portion of the projection input with one or more benchmarks and compare user input. In some embodiments, one or more benchmark comparing modules 172 may compare at least a portion of the projection input with one or more benchmarks to determine a precise match. In some embodiments, one or more benchmark comparing modules 172 may compare at least a portion of the projection input with one or more benchmarks to determine a degree of similarity.

After a start operation, the operational flow 1000 includes an initiating an action operation 1030 involving initiating an action in response to the comparing at least a portion of the projection input with one or more benchmarks. In some embodiments, one or more projection surface control units 179 may initiate an action in response to the comparing at least a portion of the projection input with one or more benchmarks. In some embodiments, one or more projection surface control units 179 may initiate an action in response to the comparing as a precise match at least a portion of the projection input with one or more benchmarks. In some embodiments, one or more projection surface control units 179 may initiate an action in response to the comparing within a degree of similarity at least a portion of the projection input with one or more benchmarks. In some embodiments, one or more projection surface control units 179 may initiate an action communicating electronically or wirelessly in response to the comparing at least a portion of the projection input with one or more benchmarks. In some embodiments, one or more projection surface control units 179 may initiate an action with one or more devices in response to the comparing at least a portion of the projection input with one or more benchmarks. In some embodiments, one or more projection surface control units 179 may initiate an action with one or more mechanical systems in response to the comparing at least a portion of the projection input with one or more benchmarks. In some embodiments, one or more projection surface control units 179 may initiate an action with one or more computer systems in response to the comparing at least a portion of the projection input with one or more benchmarks. In some embodiments, one or more projection surface control units 179 may initiate an action in accordance with one or more user instructions in response to the comparing at least a portion of the projection input with one or more benchmarks. In some embodiments, one or more projection surface control units 179 may initiate an action in accordance with one or more user attributes in response to the comparing at least a portion of the projection input with one or more benchmarks. In some embodiments, one or more projection surface control units 179 may initiate an action in accordance with one or more proximity determinations in response to the comparing at least a portion of the projection input with one or more benchmarks.

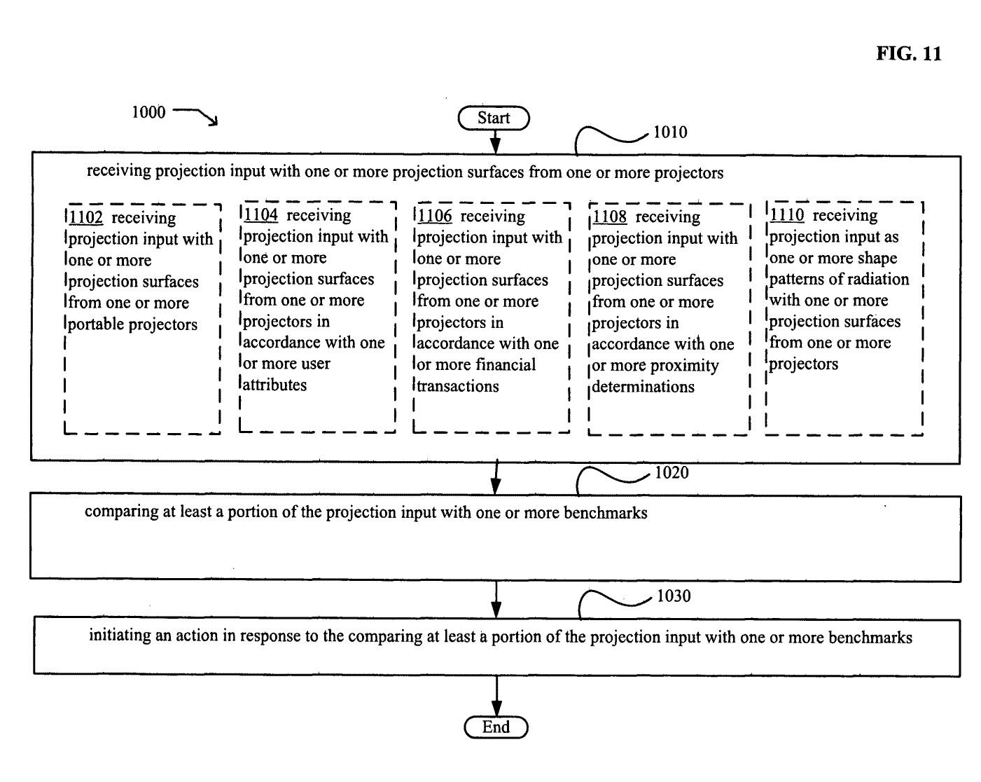

FIG. 11 illustrates alternative embodiments of the example operational flow 1000 of FIG. 10. FIG. 11 illustrates example embodiments where the receiving operation 1010 may include at least one additional operation. Additional operations may include an operation 1102, operation 1104, operation 1106, operation 1108, and/or an operation 1110.

At operation 1102, the receiving operation 1010 may include receiving projection input with one or more projection surfaces from one or more portable projectors. In some embodiments, one or more projection surfaces 166 may receive projection input with one or more projection surfaces 166 from one or more portable projectors 164. In some embodiments, one or more projection surfaces 166 may receive projection input with one or more projection surfaces 166 from one or more portable projectors 164. For example, in some embodiments, the one or more portable projectors 164 may include a keychain portable projector 164, a vehicle mounted portable projector 164, a pocket-sized portable projector 164, a purse-sized portable projector 164, a pen-sized portable projector 164, or some other similar variation thereof. Thus, in some embodiments, a projection surface 166 mounted proximate to a door may receive projection input from a pocket-sized portable projector 164 for identifying a user 110 attempting to gain access through the door. Also, in some embodiments, a projection surface 166 in communication with a computer device may receive projection input from a card-sized portable projector 164 for identifying a user 110 attempting to gain access to the computer device.

At operation 1104, the receiving operation 1010 may include receiving projection input with one or more projection surfaces from one or more projectors in accordance with one or more user attributes. In some embodiments, one or more projection surfaces 166 may receive projection input with one or more projection surfaces 166 from one or more projectors 164 in accordance with one or more user attributes. In some embodiments, one or more projection surfaces 166 may receive projection input with one or more projection surfaces 166 from one or more projectors 164 in accordance with one or more user attributes. For example, in some embodiments, one or more projection surfaces 166 may receive projection input with one or more projection surfaces 166 from one or more projectors 164 in accordance with one or more user attributes obtained from a history, a setting, a proximity determination, a sensor 156, a security parameter, a membership parameter, an account parameter, a status parameter, a group parameter, an ownership parameter, a role parameter, a capability parameter, a rights parameter, a service parameter, an activity parameter, a privilege parameter, a familial characteristic, a physical characteristic, an individualized parameter, or a contextualized parameter. For example, in some embodiments, the one or more projection surfaces 166, the projection input, or the one or more projectors 164 may be selected, accessed, or timed based upon one or more user attributes. For example, in some embodiments, the one or more projectors 164 may be accessed in accordance with a user security parameter. Also, in some embodiments, the projection input may be selected in accordance with a user membership parameter. Further, in some embodiments, the projection input may be received with the one or more projection surfaces 166 in accordance with a user proximity determination.

At operation 1106, the receiving operation 1010 may include receiving projection input with one or more projection surfaces from one or more projectors in accordance with one or more financial transactions. In some embodiments, one or more projection surfaces 166 may receive projection input with one or more projection surfaces from one or more projectors 164 in accordance with one or more financial transactions. In some embodiments, one or more projection surfaces 166 may receive projection input with one or more projection surfaces 166 from one or more projectors 164 in accordance with one or more financial transactions. For example, in some embodiments, the one or more projections surfaces 166, the projection input, or the one or more projectors 164 may be selected, accessed, or timed based upon one or more financial transactions. For example, in some embodiments, the one or more projectors 164 may require a fee for operation or may operate in coordination with a financial transaction such as purchase of a product, a service, or access. In some embodiments, the projection input may be selected based upon an amount of a financial transaction or may be selectable upon occurrence of a financial transaction. In some embodiments, the projection input may be timed to occur upon occurrence of a financial transaction. In some embodiments, the one or more projectors 164 may require a fee for operation or may operate in coordination with a financial transaction such as purchase of a produce, a service, or access. In some embodiments, one or more financial transactions may include one or more commercial transactions. For example, one or more commercial transactions may include transporting inventory, interacting with one or more customers, and/or interacting with one or more suppliers or contractors.

At operation 1108, the receiving operation 1010 may include receiving projection input with one or more projection surfaces from one or more projectors in accordance with one or more proximity determinations. In some embodiments, one or more projection surfaces 166 may receive projection input with one or more projection surfaces 166 from one or more projectors 164 in accordance with one or more proximity determinations. In some embodiments, one or more projection surfaces 166 may receive projection input with one or more projection surfaces 166 from one or more projectors 164 in accordance with one or more proximity determinations. For example, in some embodiments, the one or more projection surfaces 166, the projection input, or the one or more projectors 164 may be selected, accessed, or timed based upon a proximity determination. In some embodiments, the proximity determination may be based upon a user proximity, a device proximity, or proximity of the one or more projection surfaces 166 relative to the one or more projectors 164. For example, in some embodiments, the one or more projectors 164 may be selected upon a user 110 approaching or upon the one or more projectors 164 becoming proximate to the one or more projection surfaces 166. In some embodiments, the projection input may be timed to occur upon a user 110 approaching the one or more projectors 164 or the one or more projection surfaces 166. In some embodiments, the one or more projection surfaces 166 may be accessed upon a device becoming proximate to the one or more projectors 164 or the one or more projection surfaces 166.

At operation 1110, the receiving operation 1010 may include receiving projection input as one or more shape patterns of radiation with one or more projection surfaces from one or more projectors. In some embodiments, one or more projection surfaces 166 may receive projection input as one or more shape patterns of radiation with one or more projection surfaces 166 from one or more projectors 164. In some embodiments, one or more projection surfaces 166 may receive projection input as one or more shape patterns of radiation with one or more projection surfaces 166 from one or more projectors 164. For example, the one or more shape patterns may be a geometrical shape pattern, a combination of geometrical shape patterns, an interaction of geometrical shape patterns, a graphical shape pattern, a combination of graphical shape patterns, an interaction of graphical shape patterns, a combination of the foregoing, or some other similar shape pattern. In some embodiments, the one or more shape patterns includes at least some non-visible radiation. In some embodiments, the one or more shape patterns includes sound or motion.

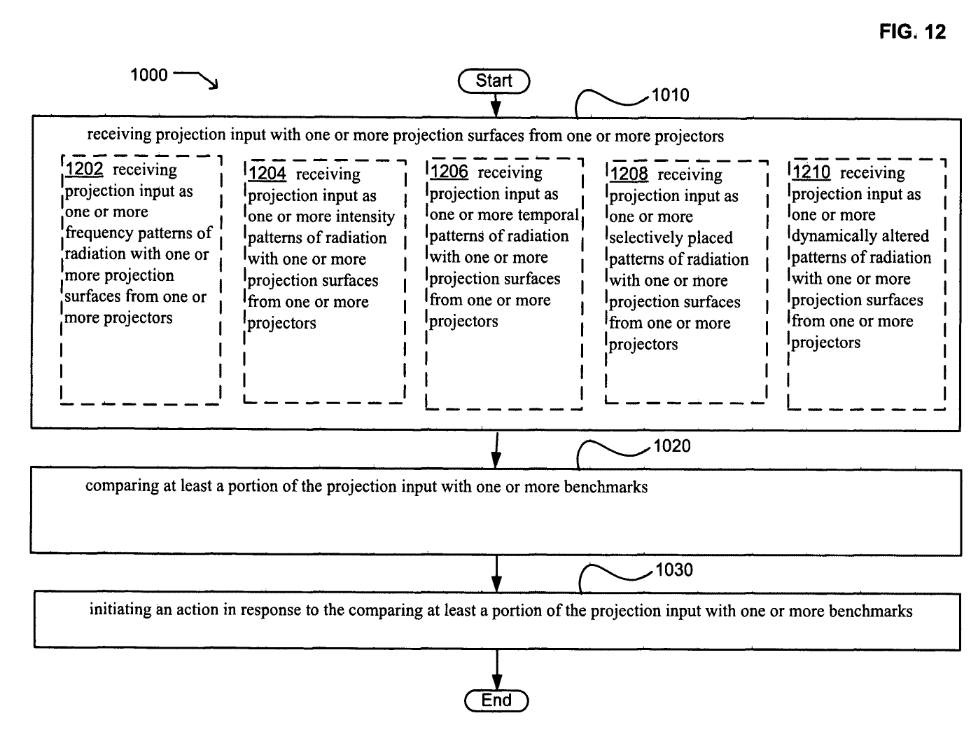

FIG. 12 illustrates alternative embodiments of the example operational flow 1000 of FIG. 10. FIG. 12 illustrates example embodiments where the receiving operation 1010 may include at least one additional operation. Additional operations may include an operation 1202, operation 1204, operation 1206, operation 1208, and/or an operation 1210.

At operation 1202, the receiving operation 1010 may include receiving projection input as one or more frequency patterns of radiation with one or more projection surfaces from one or more projectors. In some embodiments, one or more projection surfaces 166 may receive projection input as one or more frequency patterns of radiation with one or more projection surfaces 166 from one or more projectors 164. In some embodiments, one or more projection surfaces 166 may receive projection input as one or more frequency patterns of radiation with one or more projection surfaces 166 from one or more projectors 164. For example, in some embodiments, the one or more frequency patterns of radiation may be a pattern of colors, a pattern of non-visible light, a pattern of visible and non-visible light, a temporal pattern of visible and/or non-visible light, or some other similar frequency pattern of radiation. In some embodiments, the one or more frequency patterns of radiation may be two or three dimensional. In some embodiments, the one or more frequency patterns of radiation may include temporal patterns of radiation. In some embodiments, the one or more frequency patterns of radiation may include motion or sound.

At operation 1204, the receiving operation 1010 may include receiving projection input as one or more intensity patterns of radiation with one or more projection surfaces from one or more projectors. In some embodiments, one or more projection surfaces 166 may receive projection input as one or more intensity patterns of radiation with one or more projection surfaces 166 from one or more projectors 164. In some embodiments, one or more projection surfaces 166 may receive projection input as one or more intensity patterns of radiation with one or more projection surfaces 166 from one or more projectors 164. For example, the one or more intensity patterns of radiation may include a pattern of varying intensities of radiation. In some embodiments, the intensity patterns of radiation may include two or three dimensional intensity patterns of radiation. In some embodiments, the one or more intensity patterns of radiation may include temporal patterns of radiation. In some embodiments, the one or more intensity patterns of radiation may include motion or sound.

At operation 1206, the receiving operation 1010 may include receiving projection input as one or more temporal patterns of radiation with one or more projection surfaces from one or more projectors. In some embodiments, one or more projection surfaces 166 may receive projection input as one or more temporal patterns of radiation with one or more projection surfaces 166 from one or more projectors 164. In some embodiments, one or more projection surfaces 166 may receive projection input as one or more temporal patterns of radiation with one or more projection surfaces 166 from one or more projectors 164. For example, in some embodiments, the one or more temporal patterns of radiation may include a temporal pattern of radiation that forms an image over a period of time. Also, in some embodiments, the one or more temporal patterns of radiation may include a temporal pattern of radiation that may not form an image but conforms to an expected temporal pattern of radiation over a period of time. Further, in some embodiments, the one or more temporal patterns of radiation may include a series of shape patterns, frequency patterns, or intensity patterns of radiation over a period of time. In some embodiments, the one or more temporal patterns of radiation may include motion or sound.

At operation 1208, the receiving operation 1010 may include receiving projection input as one or more selectively placed patterns of radiation with one or more projection surfaces from one or more projectors. In some embodiments, one or more projection surfaces 166 may receive projection input as one or more selectively placed patterns of radiation with one or more projection surfaces 166 from one or more projectors 164. In some embodiments, one or more projection surfaces 166 may receive projection input as one or more selectively placed patterns of radiation with one or more projection surfaces 166 from one or more projectors 164. For example, in some embodiments, the one or more selectively placed patterns of radiation may include a selectively placed geometrical pattern. Also, in some embodiments, the one or more selectively placed patterns of radiation may include a selectively placed graphic or image. Further, in some embodiments, the one or more selectively placed patterns of radiation may include a selectively placed two or three dimensional pattern of radiation. In some embodiments, the one or more selectively placed patterns of radiation may include a selectively placed temporal, frequency, or intensity pattern of radiation. In some embodiments, the one or more selectively placed patterns of radiation may include motion or sound. In some embodiments, the receiving projection input as one or more selectively placed patterns of radiation may include receiving one or more patterns of radiation spatially associated with one or more other projection inputs. In some embodiments, the receiving projection input as one or more selectively placed patterns of radiation may include receiving one or more patterns of radiation spatially associated with one or more other projection inputs from a different projector. In some embodiments, the receiving projection input as one or more selectively placed patterns of radiation may include receiving one or more visible or non-visible patterns of radiation spatially associated with one or more other projection inputs.

At operation 1210, the receiving operation 1010 may include receiving projection input as one or more dynamically altered patterns of radiation with one or more projection surfaces from one or more projectors. In some embodiments, one or more projection surfaces 166 may receive projection input as one or more dynamically altered patterns of radiation with one or more projection surfaces 166 from one or more projectors 164. In some embodiments, one or more projection surfaces 166 may receive projection input as one or more dynamically altered patterns of radiation with one or more projection surfaces 166 from one or more projectors 164. For example, in some embodiments, the one or more dynamically altered patterns of radiation may include an alteration of a temporal, frequency, intensity, shape, or selectively placed patterns of radiation in response to one or more audible or visual cues, instructions, or confirmations. For example, in some embodiments, the pattern of radiation may be dynamically altered in response to movement of an image on one or more projection surfaces 166. In some embodiments, the pattern of radiation may be dynamically altered in response to a color change of an image on one or more projection surfaces 166. In some embodiments, the pattern of radiation may be dynamically altered in response to a pre-determined cue such as a sound, visual instruction, or lapse of time.

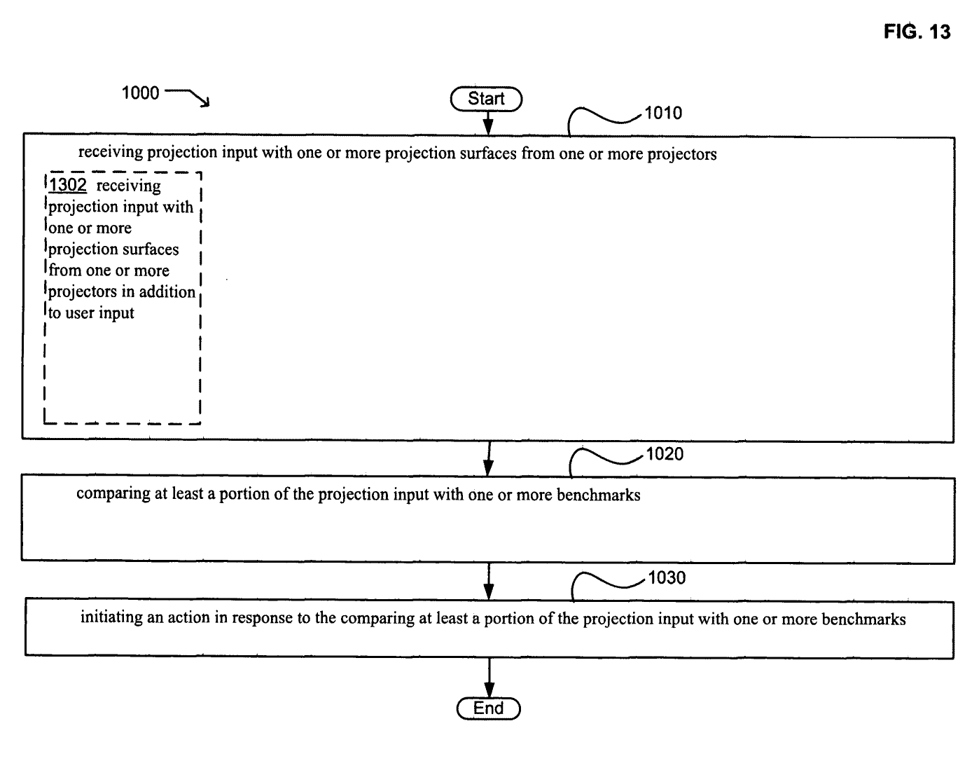

FIG. 13 illustrates alternative embodiments of the example operational flow 1000 of FIG. 10. FIG. 13 illustrates example embodiments where the receiving operation 1010 may include at least one additional operation. Additional operations may include an operation 1302.

At operation 1302, the receiving operation 1010 may include receiving projection input with one or more projection surfaces from one or more projectors in addition to user input. In some embodiments, one or more projection surfaces 166 may receive projection input with one or more projection surfaces 166 from one or more projectors 164 in addition to user input. In some embodiments, one or more projection surfaces 166 may receive projection input with one or more projection surfaces 166 from one or more projectors 164 in addition to user input. For example, in some embodiments, the user input may include a signature, voice sample, fingerprint, iris scan, or other similar authentication input. Further, in some embodiments, the user input may include a password. In some embodiments, the user input may include electronic or wireless handshake data. In some embodiments, one or more projection surfaces 166 may receive projection input with one or more projection surfaces 166 from one or more projectors 164 as markup. In some embodiments, one or more projection surfaces 166 may receive projection input with one or more projection surfaces 166 from one or more projectors 164 in addition to markup. In some embodiments, the markup is visible and/or non-visible. In some embodiments, the markup may be spatially associated with other elements of a projection input or with other elements of a separate projection input.

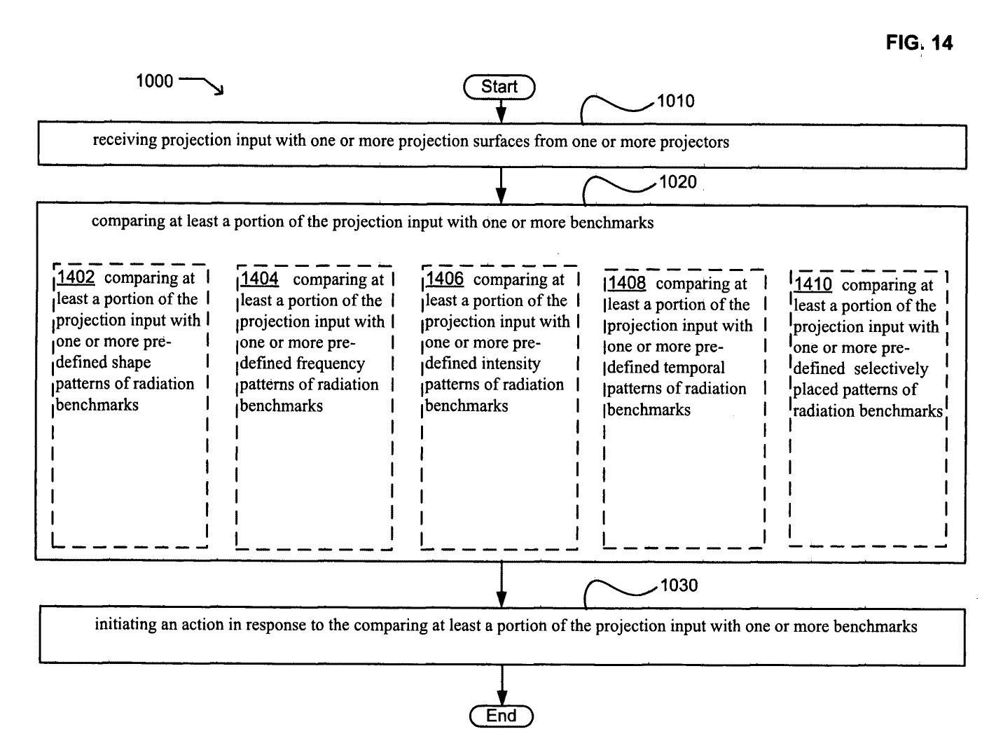

FIG. 14 illustrates alternative embodiments of the example operational flow 1000 of FIG. 10. FIG. 14 illustrates example embodiments where the comparing operation 1020 may include at least one additional operation. Additional operations may include an operation 1402, operation 1404, operation 1406, operation 1408, and/or operation 1410.

At operation 1402, the comparing operation 1020 may include comparing at least a portion of the projection input with one or more pre-defined shape patterns of radiation benchmarks. In some embodiments, one or more benchmark comparing modules 172 may compare at least a portion of the projection input with one or more pre-defined shape patterns of radiation benchmarks. For example, in some embodiments, the one or more benchmark comparing modules 172 may compare a geometrical shape pattern projection input with a pre-defined shape pattern benchmark to determine a match or a degree of similarity. Further, in some embodiments, the one or more benchmark comparing modules 172 may compare a combination of geometrical shape patterns projection input with a pre-defined shape pattern benchmark to determine a match or a degree of similarity. Also, in some embodiments, the one or more benchmark comparing modules 172 may compare an interaction of geometrical shape patterns projection input with a pre-defined shape pattern benchmark to determine a match or a degree of similarity. Additionally, in some embodiments, the one or more benchmark comparing modules 172 may compare a graphical shape pattern projection input with a pre-defined shape pattern benchmark to determine a match or a degree of similarity. Further, in some embodiments, the one or more benchmark comparing modules 172 may compare a combination of graphical shape patterns projection input with a pre-defined shape pattern benchmark to determine a match or a degree of similarity. Also, in some embodiments, the one or more benchmark comparing modules 172 may compare an interaction of graphical shape patterns projection input with a pre-defined shape pattern benchmark to determine a match or a degree of similarity. Additionally, in some embodiments, the one or more benchmark comparing modules 172 may compare a non-visible shape pattern projection input with a pre-defined shape pattern benchmark to determine a match or a degree of similarity. Further, in some embodiments, the one or more benchmark comparing modules 172 may compare sound or motion along with shape pattern projection input with a pre-defined shape pattern benchmark to determine a match or a degree of similarity.

At operation 1404, the comparing operation 1020 may include comparing at least a portion of the projection input with one or more pre-defined frequency patterns of radiation benchmarks. In some embodiments, one or more benchmark comparing modules 172 may compare at least a portion of the projection input with one or more pre-defined frequency patterns of radiation benchmarks. For example, in some embodiments, the one or more benchmark comparing modules 172 may compare color pattern projection input with a pre-defined frequency pattern benchmark to determine a match or a degree of similarity. Further, in some embodiments, the one or more benchmark comparing modules 172 may compare non-visible frequency pattern projection input with a pre-defined frequency pattern benchmark to determine a match or a degree of similarity. Also, in some embodiments, the one or more benchmark comparing modules 172 may compare visible and non-visible frequency pattern projection input with a pre-defined frequency pattern benchmark to determine a match or a degree of similarity. Additionally, in some embodiments, the one or more benchmark comparing modules 172 may compare temporal frequency pattern projection input with a pre-defined frequency pattern benchmark to determine a match or a degree of similarity. Further, in some embodiments, the one or more benchmark comparing modules 172 may compare motion or sound along with frequency pattern projection input with a pre-defined frequency pattern benchmark to determine a match or a degree of similarity.

At operation 1406, the comparing operation 1020 may include comparing at least a portion of the projection input with one or more pre-defined intensity patterns of radiation benchmarks. In some embodiments, one or more benchmark comparing modules 172 may compare at least a portion of the projection input with one or more pre-defined intensity patterns of radiation benchmarks. For example, in some embodiments, the one or more benchmark comparing modules 172 may compare a pattern of varying radiation intensity projection input with a pre-defined intensity pattern benchmark to determine a match or a degree of similarity. Further, in some embodiments, the one or more benchmark comparing modules 172 may compare a pattern of two or three dimensional radiation intensity pattern projection input with a pre-defined intensity pattern benchmark to determine a match or a degree of similarity. Also, in some embodiments, the one or more benchmark comparing modules 172 may compare a temporal pattern of radiation intensity projection input with a pre-defined intensity pattern benchmark to determine a match or a degree of similarity. Further, in some embodiments, the one or more benchmark comparing modules 172 may compare motion or sound along with a radiation intensity pattern projection input with a pre-defined intensity pattern benchmark to determine a match or a degree of similarity.

At operation 1408, the comparing operation 1020 may include comparing at least a portion of the projection input with one or more pre-defined temporal patterns of radiation benchmarks. In some embodiments, one or more benchmark comparing modules 172 may compare at least a portion of the projection input with one or more pre-defined temporal patterns of radiation benchmarks. For example, in some embodiments, the one or more benchmark comparing modules 172 may compare an image formed over a period of time projection input with a pre-defined temporal pattern benchmark to determine a match or a degree of similarity. Further, in some embodiments, the one or more benchmark comparing modules 172 may compare radiation received over a period of time projection input with a pre-defined temporal pattern benchmark to determine a match or a degree of similarity. Also, in some embodiments, the one or more benchmark comparing modules 172 may compare a series of shape patterns received over a period of time projection input with a pre-defined temporal pattern benchmark to determine a match or a degree of similarity. Additionally, in some embodiments, the one or more benchmark comparing modules 172 may compare a series of frequency patterns received over a period of time projection input with a pre-defined temporal pattern benchmark to determine a match or a degree of similarity. Further, in some embodiments, the one or more benchmark comparing modules 172 may compare a series of intensity patterns received over a period of time projection input with a pre-defined temporal pattern benchmark to determine a match or a degree of similarity. Also, in some embodiments, the one or more benchmark comparing modules 172 may compare motion or sound along with a temporal pattern projection input with a pre-defined temporal pattern benchmark to determine a match or a degree of similarity.

At operation 1410, the comparing operation 1020 may include comparing at least a portion of the projection input with one or more pre-defined selectively placed patterns of radiation benchmarks. In some embodiments, one or more benchmark comparing modules 172 may compare at least a portion of the projection input with one or more pre-defined selectively placed patterns of radiation benchmarks. For example, in some embodiments, the one or more benchmark comparing modules 172 may compare a selectively placed geometrical pattern projection input with a pre-defined selectively placed pattern benchmark to determine a match or a degree of similarity. Further, in some embodiments, the one or more benchmark comparing modules 172 may compare a selectively placed graphic or image pattern projection input with a pre-defined selectively placed pattern benchmark to determine a match or a degree of similarity. Additionally, in some embodiments, the one or more benchmark comparing modules 172 may compare a selectively placed two or three dimensional pattern projection input with a pre-defined selectively placed pattern benchmark to determine a match or a degree of similarity. Further, in some embodiments, the one or more benchmark comparing modules 172 may compare a selectively placed temporal, frequency, or intensity pattern projection input with a pre-defined selectively placed pattern benchmark to determine a match or a degree of similarity. Also, in some embodiments, the one or more benchmark comparing modules 172 may compare motion or sound along with a selectively placed pattern projection input with a pre-defined selectively placed pattern benchmark to determine a match or a degree of similarity.

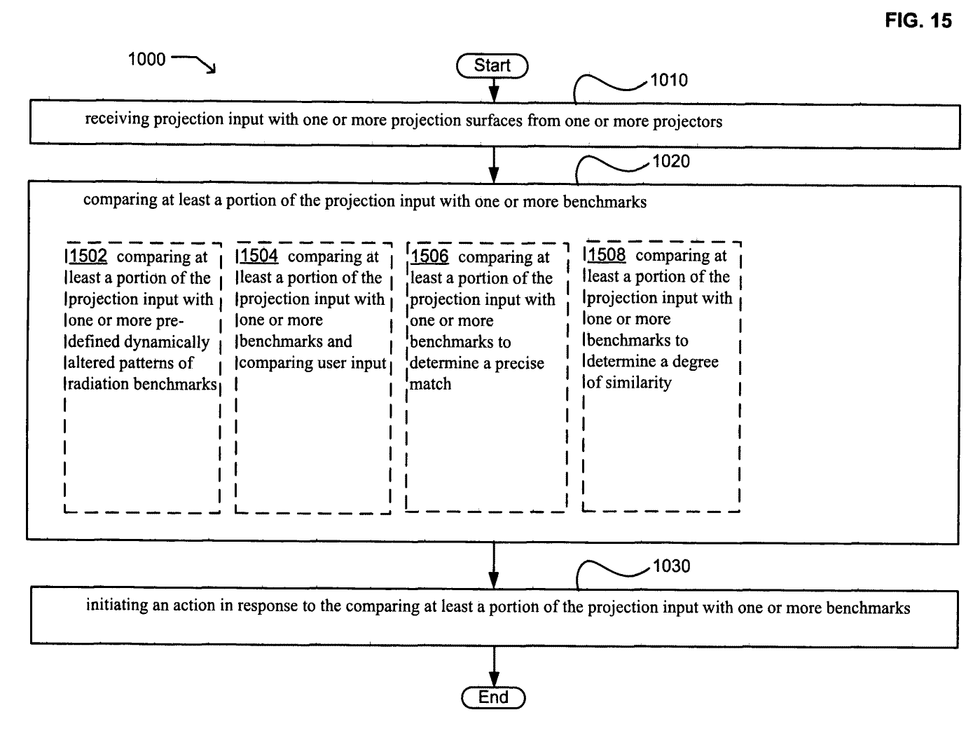

FIG. 15 illustrates alternative embodiments of the example operational flow 1000 of FIG. 10. FIG. 15 illustrates example embodiments where the comparing operation 1020 may include at least one additional operation. Additional operations may include an operation 1502, operation 1504, operation 1506, and/or operation 1508.

At operation 1502, the comparing operation 1020 may include comparing at least a portion of the projection input with one or more pre-defined dynamically altered patterns of radiation benchmarks. In some embodiments, one or more benchmark comparing modules 172 may compare at least a portion of the projection input with one or more pre-defined dynamically altered patterns of radiation benchmarks. For example, in some embodiments, the one or more benchmark comparing modules 172 may compare an alteration of a temporal pattern projection input in response to one or more audible or visual cues, instructions, or confirmations with a pre-defined dynamically altered pattern benchmark to determine a match or a degree of similarity. Further, in some embodiments, the one or more benchmark comparing modules 172 may compare an alteration of a frequency pattern projection input in response to one or more audible or visual cues, instructions, or confirmations with a pre-defined dynamically altered pattern benchmark to determine a match or a degree of similarity. Also, in some embodiments, the one or more benchmark comparing modules 172 may compare an alteration of an intensity pattern projection input in response to one or more audible or visual cues, instructions, or confirmations with a pre-defined dynamically altered pattern benchmark to determine a match or a degree of similarity. Additionally, in some embodiments, the one or more benchmark comparing modules 172 may compare an alteration of a shape pattern projection input in response to one or more audible or visual cues, instructions, or confirmations with a pre-defined dynamically altered pattern benchmark to determine a match or a degree of similarity. Further, in some embodiments, the one or more benchmark comparing modules 172 may compare an alteration of a selectively placed pattern projection input in response to one or more audible or visual cues, instructions, or confirmations with a pre-defined dynamically altered pattern benchmark to determine a match or a degree of similarity.

At operation 1504, the comparing operation 1020 may include comparing at least a portion of the projection input with one or more benchmarks and comparing user input. In some embodiments, one or more benchmark comparing modules 172 may compare at least a portion of the projection input with one or more benchmarks and compare user input. For example, in some embodiments, the one or more benchmark comparing modules 172 may compare at least a portion of the projection input with one or more benchmarks and compare a signature user input. Further, in some embodiments, the one or more benchmark comparing modules 172 may compare at least a portion of the projection input with one or more benchmarks and compare a voice sample user input. Also, in some embodiments, the one or more benchmark comparing modules 172 may compare at least a portion of the projection input with one or more benchmarks and compare a fingerprint user input. Additionally, in some embodiments, the one or more benchmark comparing modules 172 may compare at least a portion of the projection input with one or more benchmarks and compare an iris scan user input. Further, in some embodiments, the one or more benchmark comparing modules 172 may compare at least a portion of the projection input with one or more benchmarks and compare a password user input. Also, in some embodiments, the one or more benchmark comparing modules 172 may compare at least a portion of the projection input with one or more benchmarks and compare a electronic or handshake data user input.

At operation 1506, the comparing operation 1020 may include comparing at least a portion of the projection input with one or more benchmarks to determine a precise match. In some embodiments, one or more benchmark comparing modules 172 may compare at least a portion of the projection input with one or more benchmarks to determine a precise match. For example, in some embodiments, a precise match may be a geometrical shape pattern match. Further, in some embodiments, a precise match may be a frequency pattern match. Also, in some embodiments, a precise match may be an intensity pattern match. Additionally, in some embodiments, a precise match may be a temporal pattern match. Further, in some embodiments, a precise match may be a selectively placed pattern match. Also, in some embodiments, a precise match may be a dynamically altered pattern match. Additionally, in some embodiments, a precise match may be a projection input match and/or a user input match. Further, in some embodiments, a precise match may be a match within a margin of error. Additionally, in some embodiments, a precise match may be a match within a range of similarity, such as 80-100%, 70-100%, 60-100%, percentages in between the foregoing, or other similar percentages. In some embodiments, a precise match is determined by comparing pixels, shapes, lines, angles, volumes, temporal patterns, rates of change, etc.

At operation 1508, the comparing operation 1020 may include comparing at least a portion of the projection input with one or more benchmarks to determine a degree of similarity. In some embodiments, one or more benchmark comparing modules 172 may compare at least a portion of the projection input with one or more benchmarks to determine a degree of similarity. For example, in some embodiments, a degree of similarity may be a similarity of a geometrical shape pattern. Further, in some embodiments, a degree of similarity may be a similarity of a frequency pattern. Also, in some embodiments, a degree of similarity may be a similarity of an intensity pattern. Additionally, in some embodiments, a degree of similarity may be a similarity of a temporal pattern. Further, in some embodiments, a degree of similarity may be a similarity of a selectively placed pattern. Also, in some embodiments, a degree of similarity may be a similarity of a dynamically altered pattern. Additionally, in some embodiments, a degree of similarity may be a similarity of a projection input match and/or a similarity of user input. Further, in some embodiments, a degree of similarity may be a similarity within a margin of error. Also, in some embodiments, a degree of similarity may be a degree of difference. Additionally, in some embodiments, a degree of similarity may be a similarity or difference within a range, such as 80-100%, 70-100%, 60-100%, percentages in between the foregoing, or other similar percentages. In some embodiments, a degree of similarity is determined by comparing pixels, shapes, lines, angles, volumes, temporal patterns, rates of change, etc.

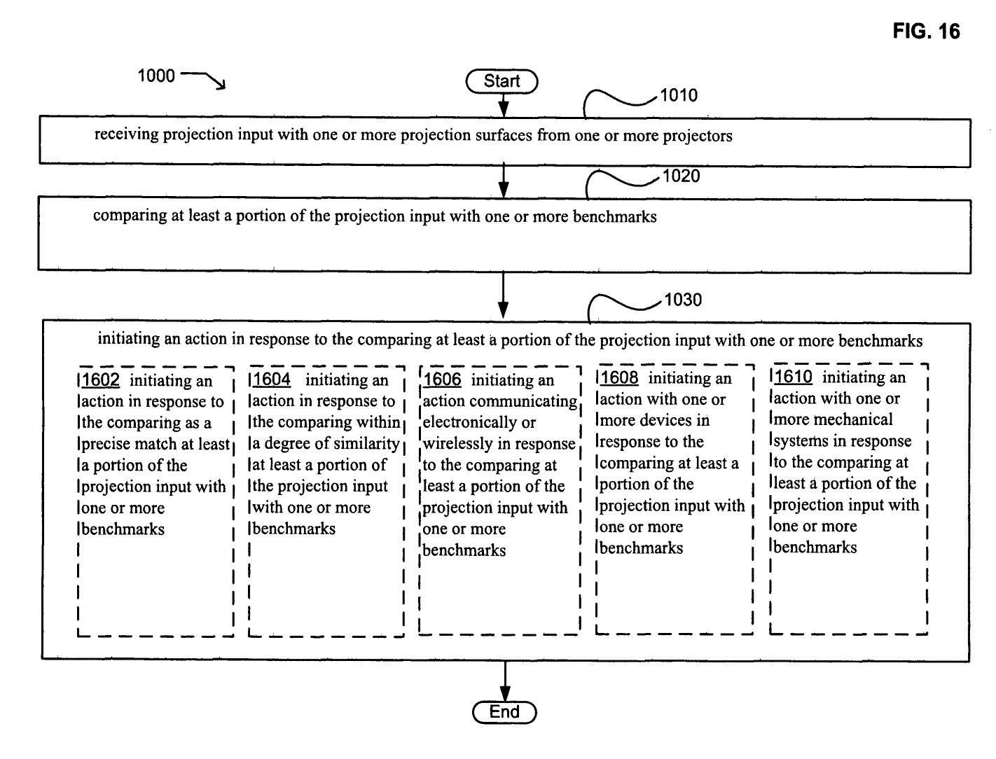

FIG. 16 illustrates alternative embodiments of the example operational flow 1000 of FIG. 10. FIG. 16 illustrates example embodiments where the initiating an action operation 1030 may include at least one additional operation. Additional operations may include an operation 1602, operation 1604, operation 1606, operation 1608, and/or operation 1610.

At operation 1602, the initiating an action operation 1030 may include initiating an action in response to the comparing as a precise match at least a portion of the projection input with one or more benchmarks. In some embodiments, one or more projection surface control units 179 initiates an action in response to the comparing as a precise match at least a portion of the projection input with one or more benchmarks. For example, in some embodiments, one or more projection surface control units 179 may initiate an action in response to a precise match of a geographical shape pattern. Further, in some embodiments, one or more projection surface control units 179 may initiate an action in response to a precise match of a frequency pattern. Also, in some embodiments, one or more projection surface control units 179 may initiate an action in response to a precise match of an intensity pattern. Additionally, in some embodiments, one or more projection surface control units 179 may initiate an action in response to a precise match of a temporal pattern. Further, in some embodiments, one or more projection surface control units 179 may initiate an action in response to a precise match of a selectively placed pattern. Also, in some embodiments, one or more projection surface control units 179 may initiate an action in response to a precise match a dynamically altered pattern. Additionally, in some embodiments, one or more projection surface control units 179 may initiate an action in response to a precise match of a projection input and/or a user input. Further, in some embodiments, one or more projection surface control units 179 may initiate an action in response to a precise match within a margin of error. Also, in some embodiments, one or more projection surface control units 179 may initiate an action automatically in response to a precise match of at least a portion of the projection input with one or more benchmarks. Additionally, in some embodiments, one or more projection surface control units 179 may initiate an action after a lapse of time in response to a precise match of at least a portion of the projection input with one or more benchmarks.

At operation 1604, the initiating an action operation 1030 may include initiating an action in response to the comparing within a degree of similarity at least a portion of the projection input with one or more benchmarks. In some embodiments, one or more projection surface control units 179 initiates an action in response to the comparing within a degree of similarity at least a portion of the projection input with one or more benchmarks. For example, in some embodiments, one or more projection surface control units 179 may initiate an action in response to a degree of similarity with a geographical shape pattern. Further, in some embodiments, one or more projection surface control units 179 may initiate an action in response to a degree of similarity with a frequency pattern. Also, in some embodiments, one or more projection surface control units 179 may initiate an action in response to a degree of similarity with an intensity pattern. Additionally, in some embodiments, one or more projection surface control units 179 may initiate an action in response to a degree of similarity with a temporal pattern. Further, in some embodiments, one or more projection surface control units 179 may initiate an action in response to a degree of similarity with a selectively placed pattern. Also, in some embodiments, one or more projection surface control units 179 may initiate an action in response to a degree of similarity with of a dynamically altered pattern. Additionally, in some embodiments, one or more projection surface control units 179 may initiate an action in response to a degree of similarity with a projection input and/or a user input. Further, in some embodiments, one or more projection surface control units 179 may initiate an action in response to a degree of similarity within a margin of error. Also, in some embodiments, one or more projection surface control units 179 may initiate an action automatically in response to a degree of similarity with at least a portion of the projection input with one or more benchmarks. Additionally, in some embodiments, one or more projection surface control units 179 may initiate an action after a lapse of time in response to a degree of similarity with at least a portion of the projection input with one or more benchmarks.

At operation 1606, the initiating an action operation 1030 may include initiating an action communicating electronically or wirelessly in response to the comparing at least a portion of the projection input with one or more benchmarks. In some embodiments, one or more projection surface control units 179 initiates an action communicating electronically or wirelessly in response to the comparing at least a portion of the projection input with one or more benchmarks. For example, in some embodiments, one or more projection surface control units 179 initiates an action electronically using computer network communication in response to the comparing at least a portion of the projection input with one or more benchmarks. Further, in some embodiments, one or more projection surface control units 179 initiates an action wirelessly using radio or light frequencies or electromagnetic flux in response to the comparing at least a portion of the projection input with one or more benchmarks. Also, in some embodiments, one or more projection surface control units 179 initiates an action electronically using a data cable or wire in response to the comparing at least a portion of the projection input with one or more benchmarks.

At operation 1608, the initiating an action operation 1030 may include initiating an action with one or more devices in response to the comparing at least a portion of the projection input with one or more benchmarks. In some embodiments, one or more projection surface control units 179 initiates an action with one or more devices in response to the comparing at least a portion of the projection input with one or more benchmarks. For example, in some embodiments, one or more projection surface control units 179 initiates an action with a computer. Further, in some embodiments, one or more projection surface control units 179 initiates an action with a network appliance. Also, in some embodiments, one or more projection surface control units 179 initiates an action with a mobile phone. Additionally, in some embodiments, one or more projection surface control units 179 initiates an action with a personal digital assistant. Further, in some embodiments, one or more projection surface control units 179 initiates an action with a software application, hardware component, memory 174, or communication component of a device. Also, in some embodiments, one or more projection surface control units 179 initiates an action to activate, deactivate, access, lock, control, adjust, or otherwise manipulate a device. In some embodiments, one or more projection surface control units 179 initiates an action with one or more projection surfaces 166, one or more projectors 164, and/or one or more projection inputs. For example, in some embodiments, one or more projection surface control units 179 intiates an action of selecting, tagging, marking up, or otherwise substituting, altering, clarifying, supplementing, or removing projection input.

At operation 1610, the initiating an action operation 1030 may include initiating an action with one or more mechanical systems in response to the comparing at least a portion of the projection input with one or more benchmarks. In some embodiments, one or more projection surface control units 179 initiates an action with one or more mechanical systems in response to the comparing at least a portion of the projection input with one or more benchmarks. For example, in some embodiments, one or more projection surface control units 179 initiates an action with a lock, such as a lock associated with a door, window, storage space, vault, or other similar system. Further, in some embodiments, one or more projection surface control units 179 initiates an action with an ignition, such as an ignition associated with a vehicle, airplane, boat, motorcycle, scooter, ATV, or other similar vehicle. Also, in some embodiments, one or more projection surface control units 179 initiates an action with a security system, such as a home security system, an office security system, or a personal security system. Additionally, in some embodiments, one or more projection surface control units 179 initiates an action to activate, deactivate, access, lock, adjust, control or otherwise manipulate a mechanical system.

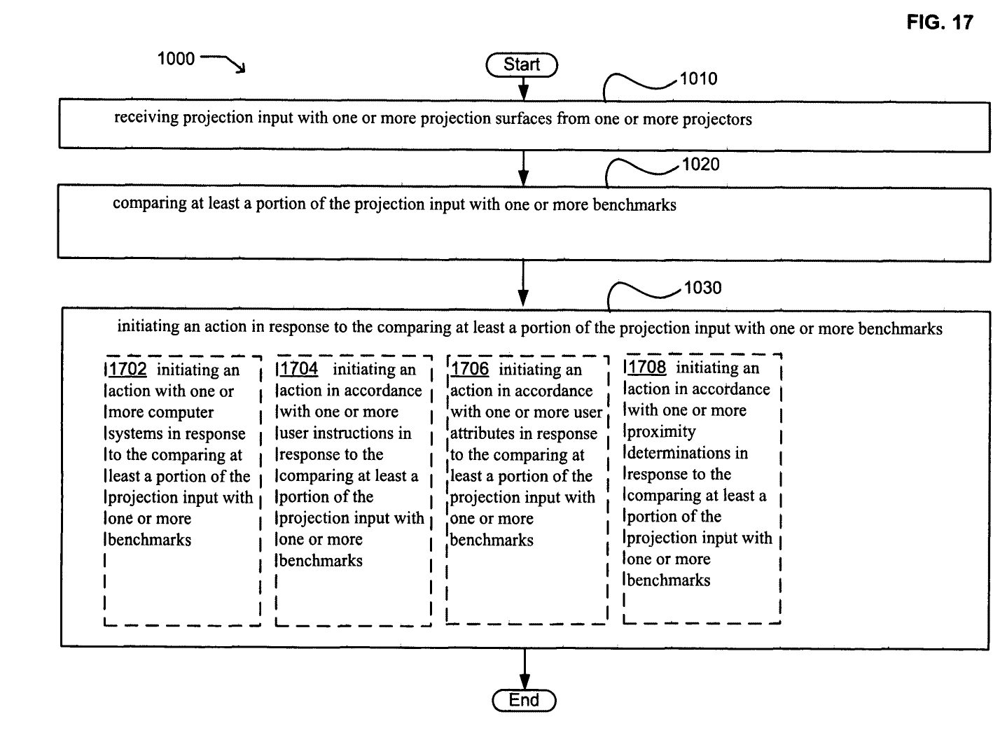

FIG. 17 illustrates alternative embodiments of the example operational flow 1000 of FIG. 10. FIG. 17 illustrates example embodiments where the initiating an action operation 1030 may include at least one additional operation. Additional operations may include an operation 1702, operation 1704, operation 1706, and/or operation 1708.

At operation 1702, the initiating an action operation 1030 may include initiating an action with one or more computer systems in response to the comparing at least a portion of the projection input with one or more benchmarks. In some embodiments, one or more projection surface control units 179 initiates an action with one or more computer systems in response to the comparing at least a portion of the projection input with one or more benchmarks. For example, in some embodiments, one or more projection surface control units 179 initiates an action with a personal computer. Further, in some embodiments, one or more projection surface control units 179 initiates an action with a server computer. Also, in some embodiments, one or more projection surface control units 179 initiates an action with a portable computer. Additionally, in some embodiments, one or more projection surface control units 179 initiates an action with a software application, hardware component, memory 174, or communication component of a computer system.

At operation 1704, the initiating an action operation 1030 may include initiating an action in accordance with one or more user instructions in response to the comparing at least a portion of the projection input with one or more benchmarks. In some embodiments, one or more projection surface control units 179 initiates an action in accordance with one or more user instructions in response to the comparing at least a portion of the projection input with one or more benchmarks. For example, in some embodiments, one or more projection surface control units 179 initiates an action in accordance with a user instruction providing a command. Further, in some embodiments, one or more projection surface control units 179 initiates an action in accordance with a user instruction identifying a device, mechanical system, computer system, or communication method, source, or destination. Additionally, in some embodiments, one or more projection surface control units 179 initiates an action in accordance with a user instruction selecting an option. In some embodiments, the user instruction is received via menu interaction, sound, or a gesture.

At operation 1706, the initiating an action operation 1030 may include initiating an action in accordance with one or more user attributes in response to the comparing at least a portion of the projection input with one or more benchmarks. In some embodiments, one or more projection surface control units 179 initiates an action in accordance with one or more user attributes in response to the comparing at least a portion of the projection input with one or more benchmarks. For example, in some embodiments, one or more projection surface control units 179 initiates an action in accordance with a user attribute obtained from a history, a setting, a proximity determination, a sensor 156, a security parameter, a membership parameter, an account parameter, a status parameter, a group parameter, an ownership parameter, a role parameter, a capability parameter, a rights parameter, a service parameter, an activity parameter, a privilege parameter, a familial characteristic, a physical characteristic, an individualized parameter, or a contextualized parameter. For example, in some embodiments, the action can be selected, allowed, or timed based upon one or more user attributes. For example, in some embodiments an action may be allowed in accordance with a user security parameter. Also, in some embodiments, an action may be selected in accordance with a user membership parameter. Further, in some embodiments, an action may be timed in accordance with a user proximity determination.

At operation 1708, the initiating an action operation 1030 may include initiating an action in accordance with one or more proximity determinations in response to the comparing at least a portion of the projection input with one or more benchmarks. In some embodiments, one or more projection surface control units 179 initiates an action in accordance with one or more proximity determinations in response to the comparing at least a portion of the projection input with one or more benchmarks. For example, in some embodiments, one or more projection surface control units 179 may initiate an action with a device, a mechanical system, a computer system, or communication method, source, or destination based on one or more proximity determinations. In some embodiments, the proximity determination may be based upon a user proximity, a device proximity, or proximity of the one or more projection surfaces 166 relative to the one or more projectors 164. For example, in some embodiments, a lock may be opened upon a user 110 approaching the lock. Further, in some embodiments, communication may be initiated upon a device approaching the communication source. Additionally, a mechanical system may become inaccessible upon a user 110 moving from the mechanical system.

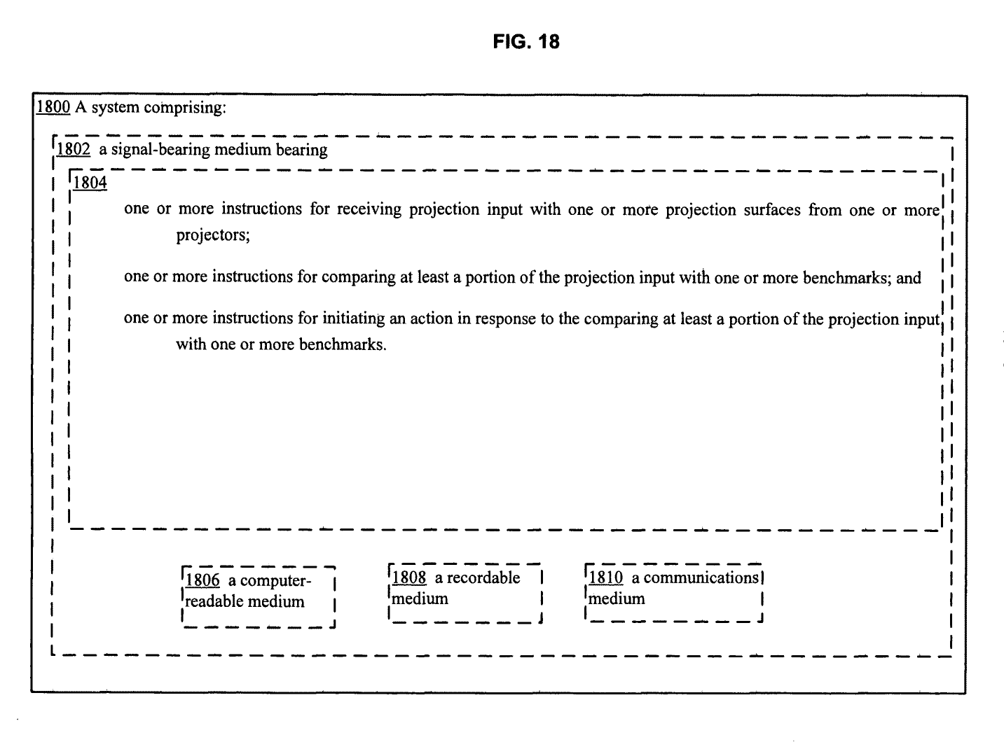

FIG. 18 illustrates a partial view of a system 1800 that includes a computer program 1804 for executing a computer process on a computing device. An embodiment of system 1800 is provided using a signal-bearing medium 1802 bearing one or more instructions for receiving projection input with one or more projection surfaces from one or more projectors; one or more instructions for comparing at least a portion of the projection input with one or more benchmarks; and one or more instructions for initiating an action in response to the comparing at least a portion of the projection input with one or more benchmarks. The one or more directions may be, for example, computer executable and/or logic-implemented instructions. In some embodiments, the signal-bearing medium 1802 may include a computer-readable medium 1806. In some embodiments, the signal-bearing medium 1802 may include a recordable medium 1808. In some embodiments, the signal-bearing medium 1802 may include a communications medium 1810.

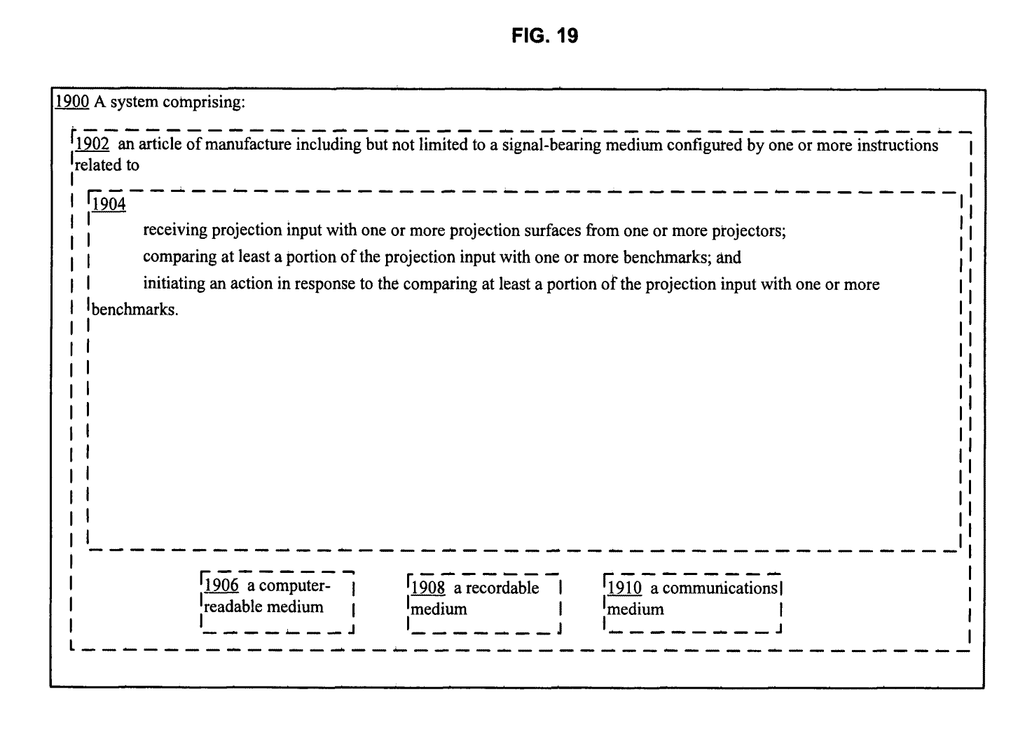

FIG. 19 illustrates a partial view of a system 1900 that includes a computer program 1904 for executing a computer process on a computing device. An embodiment of system 1900 is provided using an article of manufacture including but not limited to a signal-bearing medium 1902 configured by one or more instructions related to receiving projection input with one or more projection surfaces from one or more projectors; comparing at least a portion of the projection input with one or more benchmarks; and initiating an action in response to the comparing at least a portion of the projection input with one or more benchmarks. The one or more directions may be, for example, computer executable and/or logic-implemented instructions. In some embodiments, the article of manufacture 1902 may include a computer-readable medium 1906. In some embodiments, the article of manufacture 1902 may include a recordable medium 1908. In some embodiments, the article of manufacture 1902 may include a communications medium 1910.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled//implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs. Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will recognize that at least a portion of the devices and/or processes described herein can be integrated into an image processing system. Those having skill in the art will recognize that a typical image processing system generally includes one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

Those skilled in the art will recognize that at least a portion of the devices and/or processes described herein can be integrated into a mote system. Those having skill in the art will recognize that a typical mote system generally includes one or more memories such as volatile or non-volatile memories, processors such as microprocessors or digital signal processors, computational entities such as operating systems, user interfaces, drivers, sensors, actuators, applications programs, one or more interaction devices (e.g., an antenna USB ports, acoustic ports, etc.), control systems including feedback loops and control motors (e.g., feedback for sensing or estimating position and/or velocity; control motors for moving and/or adjusting components and/or quantities). A mote system may be implemented utilizing suitable components, such as those found in mote computing/communication systems. Specific examples of such components entail such as Intel Corporation's and/or Crossbow Corporation's mote components and supporting hardware, software, and/or firmware.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory). A sale of a system or method may likewise occur in a territory even if components of the system or method are located and/or used outside the territory. Further, implementation of at least part of a system for performing a method in one territory does not preclude use of the system in another territory.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

Although user 110 is shown/described herein as a single illustrated figure, those skilled in the art will appreciate that user 110 may be representative of a human user, a robotic user (e.g., computational entity), and/or substantially any combination thereof (e.g., a user may be assisted by one or more robotic agents) unless context dictates otherwise. Those skilled in the art will appreciate that, in general, the same may be said of “sender” and/or other entity-oriented terms as such terms are used herein unless context dictates otherwise.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configurable to,” “operable/operative to,” “adapted/adaptable,” “able to,” “conformable/conformed to,” etc. Those skilled in the art will recognize that such terms (e.g. “configured to”) can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

All of the above U.S. patents, U.S. patent application publications, U.S. patent applications, foreign patents, foreign patent applications and non-patent publications referred to in this specification and/or listed in any Application Data Sheet, are incorporated herein by reference, to the extent not inconsistent herewith.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method comprising:
receiving projection input with one or more projection surfaces from one or more projectors;
comparing at least a portion of the projection input with one or more benchmarks; and
initiating an action in response to the comparing at least a portion of the projection input with one or more benchmarks.

2. The method of claim 1, wherein the receiving projection input with one or more projection surfaces from one or more projectors comprises:
receiving projection input with one or more projection surfaces from one or more portable projectors.

3. The method of claim 1, wherein the receiving projection input with one or more projection surfaces from one or more projectors comprises:
receiving projection input with one or more projection surfaces from one or more projectors in accordance with one or more user attributes.

4. The method of claim 1, wherein the receiving projection input with one or more projection surfaces from one or more projectors comprises:
receiving projection input with one or more projection surfaces from one or more projectors in accordance with one or more financial transactions.

5. The method of claim 1, wherein the receiving projection input with one or more projection surfaces from one or more projectors comprises:
receiving projection input with one or more projection surfaces from one or more projectors in accordance with one or more proximity determinations.

6. The method of claim 1, wherein the receiving projection input with one or more projection surfaces from one or more projectors comprises:
receiving projection input as one or more shape patterns of radiation with one or more projection surfaces from one or more projectors.

7. The method of claim 1, wherein the receiving projection input with one or more projection surfaces from one or more projectors comprises:
receiving projection input as one or more frequency patterns of radiation with one or more projection surfaces from one or more projectors.

8. The method of claim 1, wherein receiving projection input with one or more projection surfaces from one or more projectors comprises:
receiving projection input as one or more intensity patterns of radiation with one or more projection surfaces from one or more projectors.

9. The method of claim 1, wherein the receiving projection input with one or more projection surfaces from one or more projectors comprises:
receiving projection input as one or more temporal patterns of radiation with one or more projection surfaces from one or more projectors.

10. The method of claim 1, wherein the receiving projection input with one or more projection surfaces from one or more projectors comprises:
receiving projection input as one or more selectively placed patterns of radiation with one or more projection surfaces from one or more projectors.

11. The method of claim 1, wherein the receiving projection input with one or more projection surfaces from one or more projectors comprises:
receiving projection input as one or more dynamically altered patterns of radiation with one or more projection surfaces from one or more projectors.

12. The method of claim 1, wherein the receiving projection input with one or more projection surfaces from one or more projectors comprises:
receiving projection input with one or more projection surfaces from one or more projectors in addition to user input.

13. The method of claim 1, wherein the comparing at least a portion of the projection input with one or more benchmarks comprises:
comparing at least a portion of the projection input with one or more pre-defined shape patterns of radiation benchmarks.

14. The method of claim 1, wherein the comparing at least a portion of the projection input with one or more benchmarks comprises:
comparing at least a portion of the projection input with one or more pre-defined frequency patterns of radiation benchmarks.

15. The method of claim 1, wherein the comparing at least a portion of the projection input with one or more benchmarks comprises:
comparing at least a portion of the projection input with one or more pre-defined intensity patterns of radiation benchmarks.

16. The method of claim 1, wherein the comparing at least a portion of the projection input with one or more benchmarks comprises:
comparing at least a portion of the projection input with one or more pre-defined temporal patterns of radiation benchmarks.

17. The method of claim 1, wherein the comparing at least a portion of the projection input with one or more benchmarks comprises:
comparing at least a portion of the projection input with one or more pre-defined selectively placed patterns of radiation benchmarks.

18. The method of claim 1, wherein the comparing at least a portion of the projection input with one or more benchmarks comprises:
comparing at least a portion of the projection input with one or more pre-defined dynamically altered patterns of radiation benchmarks.

19. The method of claim 1, wherein the comparing at least a portion of the projection input with one or more benchmarks comprises:
comparing at least a portion of the projection input with one or more benchmarks and comparing user input.

20. The method of claim 1, wherein the comparing at least a portion of the projection input with one or more benchmarks comprises:
comparing at least a portion of the projection input with one or more benchmarks to determine a precise match.

21. The method of claim 1, wherein the comparing at least a portion of the projection input with one or more benchmarks comprises:
comparing at least a portion of the projection input with one or more benchmarks to determine a degree of similarity.

22. The method of claim 1, wherein the initiating an action in response to the comparing at least a portion of the projection input with one or more benchmarks comprises:
initiating an action in response to the comparing as a precise match at least a portion of the projection input with one or more benchmarks.

23. The method of claim 1, wherein the initiating an action in response to the comparing at least a portion of the projection input with one or more benchmarks comprises:
initiating an action in response to the comparing within a degree of similarity at least a portion of the projection input with one or more benchmarks.

24. The method of claim 1, wherein the initiating an action in response to the comparing at least a portion of the projection input with one or more benchmarks comprises:
initiating an action communicating electronically or wirelessly in response to the comparing at least a portion of the projection input with one or more benchmarks.

25. The method of claim 1, wherein the initiating an action in response to the comparing at least a portion of the projection input with one or more benchmarks comprises:
initiating an action with one or more devices in response to the comparing at least a portion of the projection input with one or more benchmarks.

26. The method of claim 1, wherein the initiating an action in response to the comparing at least a portion of the projection input with one or more benchmarks comprises:
initiating an action with one or more mechanical systems in response to the comparing at least a portion of the projection input with one or more benchmarks.

27. The method of claim 1, wherein the initiating an action in response to the comparing at least a portion of the projection input with one or more benchmarks comprises:
initiating an action with one or more computer systems in response to the comparing at least a portion of the projection input with one or more benchmarks.

28. The method of claim 1, wherein the initiating an action in response to the comparing at least a portion of the projection input with one or more benchmarks comprises:
initiating an action in accordance with one or more user instructions in response to the comparing at least a portion of the projection input with one or more benchmarks.

29. The method of claim 1, wherein the initiating an action in response to the comparing at least a portion of the projection input with one or more benchmarks comprises:
initiating an action in accordance with one or more user attributes in response to the comparing at least a portion of the projection input with one or more benchmarks.

30. The method of claim 1, wherein the initiating an action in response to the comparing at least a portion of the projection input with one or more benchmarks comprises:
initiating an action in accordance with one or more proximity determinations in response to the comparing at least a portion of the projection input with one or more benchmarks.

31-60. (canceled)

61. A system comprising:
a signal-bearing medium bearing:
one or more instructions for receiving projection input with one or more projection surfaces from one or more projectors;
one or more instructions for comparing at least a portion of the projection input with one or more benchmarks; and
one or more instructions for initiating an action in response to the comparing at least a portion of the projection input with one or more benchmarks.

62. The system of claim 61, wherein the signal-bearing medium includes a computer-readable medium.

63. The system of claim 61, wherein the signal-bearing medium includes a recordable medium.

64. The system of claim 61, wherein the signal-bearing medium includes a communications medium.

65. A system comprising:
an article of manufacture including but not limited to a signal-bearing medium configured by one or more instructions related to:
receiving projection input with one or more projection surfaces from one or more projectors;
comparing at least a portion of the projection input with one or more benchmarks; and
initiating an action in response to the comparing at least a portion of the projection input with one or more benchmarks.

66. The system of claim 65, wherein the article of manufacture includes a signal-bearing medium that includes a computer-readable medium.

67. The system of claim 65, wherein the article of manufacture includes a signal-bearing medium that includes a recordable medium.

68. The system of claim 65, wherein the article of manufacture includes a signal-bearing medium that includes a communications medium.

69. A system comprising:
means for receiving projection input with one or more projection surfaces from one or more projectors;
means for comparing at least a portion of the projection input with one or more benchmarks; and
means for initiating an action in response to the comparing at least a portion of the projection input with one or more benchmarks.
